(19) United States
(12) Patent Application Publication
(10) Pub. No.: US 2014/0047999 A1
(43) Pub. Date: Feb. 20, 2014

(54) ACID AND HIGH TEMPERATURE RESISTANT CEMENT COMPOSITES

(71) Applicant: Ivan Ràzl, Zlin (CZ)

(72) Inventor: Ivan Ràzl, Zlin (CZ)

(21) Appl. No.: 13/989,069

(22) PCT Filed: Nov. 14, 2011
(86) PCT No.: PCT/CZ2011/000109

§ 371 Date: Jun. 19, 2013

(30) Foreign Application Priority Data
Nov. 23, 2010 (CZ) PV 2010-855

(51) Int. Cl. C04B 28/02

(52) U.S. Cl. CPC C04B 28/021
USPC 106/676; 106/705; 106/708; 106/707; 106/698; 106/679

(57) ABSTRACT

Process for production of acid and high temperature resistant cement composites, where the matrix is alkali activated F fly ash alone, F Fly ash combined with ground slag or ground slag alone. F-fly ash produces lower quality alkali activated cement systems. On the other hand the lack of calcium oxide results in very high resistance to medium and highly concentrated inorganic or organic acids. The high strength and low permeability of pure F-fly ash cement systems is achieved by using in the composition un-densified silica fume, the amorphous silicone dioxide obtained as by products in production of ferro-silicones. Precipitated nano-particle silica made from soluble silicates and nano-particle silica fume produced by burning silicon tetra chloride in the hydrogen stream.

### TECHNICAL FIELD

The invention regards a acid and high temperature resistant cement composites

### BACKGROUND OF THE INVENTION

The alkali cements represent a class of inorganic binders, in which the alkaline component provides the structure forming element. This class is different from conventional cements, such as Portland, calcium aluminate, slag cements or others, where the alkali elements act as a catalyst of the hydration reaction. The classes of alkali cement are mixtures of alkalis, compounds of the first group of the Periodic Table, and alumino-silicates of natural or artificial origin. The modern research of this class cements starts probably with Purdon (1940) who described alkali activation of blast furnace slag. The considerable amount of work on alkali activation has been done in Russia, as long ago as in 1957. Glukhovskii (1967) has introduced so called “soil cements” binders and “soil silicate” concretes. The alkali activated cements are also known under other names: alkali activated cements Narang & Chopra, 1983; SKJ binder (Lu Changgo, 1991), F-cements (Forss 1983), Gypsum Free Cement (Odler, Skalny and Branauer, 1993); and geocements (Krivenko & Skurcinskaja, 1991).

In 1973 Davidovits was granted first patent for alumino-silicate cements. The manufacturing of these cements consisted of the following steps: mixing kaolinite, lime stone, dolomite; calcining of this mix and introduction of alkaline compound solutions. During this process, the kaolinite converts to metakaolinite, (Al₂O₃.2SiO₂) gaining the pozzolanic properties, while calcium and magnesium carbonates form calcium and magnesium oxides The addition of sodium or potassium hydroxides initiates a chemical reaction with polysilicate and aluminosilicate oxides forming hydration products represented by analcime (AlSi₂O₆—H₂O) and hydrosodalite (Na₈[AlSiO₄].8H₂O). Some of these products have been known under the trade names: Geopolycem, Geopymite etc. under the general name “geopolymers”. Krivenko (1997) proposed a classification of alkali activated cements based on “boundary” characteristic features of the products of hydration and hardening: alkaline hydros-aluminosilicates of the system R₂O—Al₂O₃—SiO₂—H₂O and alkali-earth hydrosilicates. A variety of blended cements exist within these “boundary” edges. (R2O represents Na₂O, K₂O, Li₂O).

The cement binders described in this application are represented mainly by the first group of the alkaline hydros-aluminosilicates (the compositions based only on F Fly Ash and the blended cements, based on alkaline hydros-aluminosilicates in combination with alkali-earth hydrosilicates (the compositions based on F-Fly ash in combination with ground slag. The acid resistance and particularly the resistance to sulfuric acid is controlled by minimizing the calcium oxide content on the alkali activated cement binder. It will be shown that the highest resistance to sulfuric acid is achieved by compositions based on 100% F-Fly ash. An addition of ground slag into the composition reduces the resistance to sulfuric acid. The 100% ground slag composition has a high resistance to acid, but its resistance to sulfuric acid is reduced. The reduction in chemical resistance to sulfuric acid is due to formation of expansive calcium alumino-silicate in form of ettringite (CaO)₆(Al₂O₃×SO₃)₃ 32 H₂O. Background—an acid resistance—advantages of the presented cement composites, when compared with existing solutions (technology). The conventional Portland cement based mortars and concrete exhibit very limited or no resistance to acidic environments. For example the conventional Portland cement concrete, with low water cement ratio around 0.4 will completely disintegrate in 10% sulfuric acid within 140-160 days. The acid resistance can be marginally increased by using calcium aluminate cement binders, instead of calcium silicate (Portland cement) binders. The sodium or potassium silicate mortars and concretes represent another group of acid resistant materials, in which the binder is the silicate with silica dioxide such as silica sand or coarse silica aggregates. The key disadvantage of these mortars and concrete is their high sensitivity to moisture or diluted acids, and for this reason their acid resistance and hence the use is limited. The acid resistant ceramic tiles or brick offer another group of materials, which exhibit a very high acid resistance to almost any acid concentration and are therefore used in concrete floor or tank applications as acid protective layer. But the ceramic tiles or ceramic bricks are manufactured in small sizes, resulting in a great area of joints and the need for adhesives to bond them to concrete and steel. The joint grouts and bonding adhesives are typically sodium or potassium based silicate mortars, with serious disadvantage described above. Therefore the acid resistance of the ceramic tile or brick system is controlled to great extent by relatively poor moisture and diluted acid resistance of silicate mortars. The acids penetrate through the joints and resulting in deterioration of the tile/brick protective system by de-bonding. The additional disadvantage of ceramic tile or brick material is their high cost due to high temperature treatment (firing) required in manufacturing of ceramic materials. Another group of materials which are used as protective layers for steel and concrete in acid environments are viny-ester, novolak, special epoxy phenolic resins and other resins, as well as rubbers, such as acrylo-nitrile rubber. The key disadvantage of these materials is their limited temperature resistance and considerably different thermal expansion and contraction coefficient when compared with those of steel and concrete. This difference, at even slightly elevated temperatures, results in de-bonding of the polymeric materials. The polymer based materials are not “breathable”, their water vapor transmission is close to zero and they act as vapor barriers. In application to concrete the polymer materials, with a low “breathability”, (a low water vapor transmission) de-bond due to moisture transfer which often occurs in the substrate concrete. Similarly, even a very small amount, a molecular layer of water, present on the surface of steel or concrete, due to condensation of water vapor on the surface, causes serious bonding problems of polymeric materials. Also, the cost of these materials is very high and their application to concrete or steel is difficult and very sensitive to surface preparation, relative humidity and moisture content (e.g. condensed film) on the surface of steel or in concrete. The existing patent literature and other sources describe the improved acid resistance of alkali activated cements, when compared with very low acid resistance of conventional Portland cement (alkali-earth hydro-silicates), but the below referenced patents do not distinguish between resistance to acids in general and difference between the acid resistance of F-Fly Ash and C-Fly ash composites. The presented cement composites do not have the disadvantages of the above described materials. The acid resistance is the same as that of high acid resistant ceramic tiles and bricks. Since these materials can be used as mortar or concrete, it is possible to apply them without joints, eliminating the key limiting disadvantage of the ceramic tiles and bricks. Even in case of their prefabrication into acid resistant bricks and tiles, the same cement composites can be used as joint grout and bonding adhesive, exhibiting the same acid and moisture resistance. The presence of alkali activated F-Fly ash alone or in combination with slag provides an excellent water and diluted acid resistance, while having a resistance to highly concentrated acids, when compared with conventional sodium and potassium silicate binders. The thermal expansion and contraction of disclosed cement compositions is very similar to those of concrete and steel, therefore the de-bonding problems caused by differential thermally induced movements, at the interface of the substrate and the protective material, do not exist. The presented composites are “breathable” and exhibit a similar water vapor transmission as Portland cement mortars and concrete. Thus the de-bonding problem of polymeric materials is eliminated. The disclosed composites also bond very well to concrete and steel, even when the substrates are wet and they can be applied in very high humidity environments. A very important characteristic of the presented cement composites is their high temperature resistance. Even at conventional density, around 2.2 g/cm³, they will resist in long term temperatures up to 800° C., far exceeding the temperature resistance of polymeric materials. The very important characteristic of these materials is the combination of described properties, namely the acid and temperature resistance, “breathability” in applications to concrete, thermal compatibility with the concrete and steel substrates, insensitivity to surface or atmospheric moisture during application and high bond under those conditions to both, steel and concrete surfaces. Very important advantage is their lower cost, in comparison with all acid resistant materials mentioned. The presented cement composites are easy to manufacture and use in site as well as in casting or pre-casting applications. Background—a high temperature resistance—advantages of the presented cement composites, when compared with existing solutions (technology).

Portland cement mortars and concrete are inorganic, non-flammable materials. But in temperatures over 100° C. the water of hydration is gradually escaping from calcium hydro silicates and the material rapidly lose their strength. This process is relatively slow at low temperatures from 100° C. to 400° C., but is rapidly accelerated at higher temperatures. The temperature resistance is improved by incorporating lightweight aggregates such as expanded perlite or vermiculate and other inorganic lightweight aggregates. These compositions are used as fireproofing materials of steel structures, but they protect the structural steel relatively short period of time. The high temperature resistance is considerably improved by using calcium aluminate cements in mortars and concrete. Calcium aluminate cement at elevated temperatures is converted to a ceramic-like and exhibits good temperature resistance for extended periods of time. The lightweight calcium aluminate cements, while theoretically possible, are un-known in construction or industrial applications. The thermal insulating properties (reduction of heat transfer) of Portland or calcium aluminate cements are very limited for using these materials as thermal insulating materials. The inorganic thermal insulating materials include glass and mineral wools. Some types are completely non-flammable by a proper selection of the fiber binder. They have very good thermal insulating characteristics, but have no or very minimal strength. The glass fiber insulation starts breaking down at temperatures above 230-250° C. The basalt (rock wool) fiber insulation exhibits a higher temperatures resistance when compared with glass wool, but will break down at temperatures above 700-850° C. Their additional disadvantage is water sensitivity, a high water absorption and low resistance to direct flame. The mineral fibers, even basaltic fibers, melt fast and the fibrous insulting material disintegrates when exposed to direct flame. Another non-flammable thermal insulating material is foamed glass. This material is extensively used as high temperature insulation for its very good thermal insulating characteristics and adequate strength, but it starts softening and breaking down at temperatures around 430° C. and as in case of glass or mineral fiber insulations it will not resist direct flame. The foamed glass is a very expensive material and must used in form of pre-fabricated blocks. Refractories have an excellent high temperature, but very low thermal insulating capacity. They are also typically used in form of prefabricated blocks or bricks. A special group is represented by a high performance lightweight ceramic material used in aerospace. They exhibit both, high temperature resistance; high thermal insulation and are lightweight. These materials are very expensive and their application is limited to protection of a shuttle vehicle and in similar applications.

The disclosure describes several types of lightweight material based on alkali activated F-Fly ash and F-Fly ash blends with ground slag binder. There are several types described and can be divided by density to two major groups. The first group is represented by cement composites which utilize lightweight aggregates such as cenospheres (the lightweight fraction of fly-ash) or other lightweight, high performance aggregates such as porous glass particles. The typical densities of these materials vary typically from 2.1 g/cm³ to 1 g/cm³. The densities between 2.2 g/cm³ to approximately 0.2 g/cm³ is achieved by several methods described in the disclosure:

a. Foaming the composition on mixing using surface acting agents
b. Blending of pre-formed foam with the binder
c. Gas generation

The compositions utilizing lightweight aggregates are lighter than conventional concrete or mortars and exhibit temperature resistance in excess of 800° C. The compressive strength at given specific density is not decreased by exposure to high temperatures as it is in case of Portland cement, mineral wool or formed glass. The strength is increased by continuation of the chemical reaction of the binder. By using preformed foam, very light composites are obtained with good thermal insulating characteristics. The materials exhibit a very high resistance to direct flame, e.g. propane torch which gives temperatures around 1300° C. The materials turn to red color, when exposed for extended length of time to direct flame of the propane torch, without melting, decomposition or burn-through, typical for glass, mineral wool or foam glass materials. Very important feature of these materials is that their use is not limited to form of prefabricated blocks or boards as above described materials. They can be placed in liquid form to any sealed cavity, as well as manufactured to form blocks and boards.

An additional characteristic of these materials is the combination of acid and high temperature resistance, and acid resistance at elevated temperatures. The conventional materials described above with exception of refractory materials and high performance aerospace ceramic composites, do not exhibit these properties. An important aspect of the cement composites presented in this disclosure is their virtually no negative environmental impact, since the most important part of the composite, the binder, uses large amounts of waste materials, namely F-Fly ash and slag. Also important is their easy manufacturing and low cost.

Below is more detail analysis of existing patents in respect to present disclosure. The reference consists of short description of the patent (or patent application). The bolded texts describe the difference between the patent and the present disclosure.

Patent Review—Acid Resistance Glukhovsky et al, U.S. Pat. No. 4,410,365. BINDER. Glukhovsky et al describe an inorganic binder comprising granulated blast furnace slag, a compound of an alkali metal silicate, and an additive selected from the group consisting from Portland cement clinker, sodium sulphate, potassium sulphate. The key composition contains granulated slag, sodium metasilicate and one of the above mentioned additives. Note: The compositions described in the patent contain a high amount of calcium oxide and will not exhibit chemical resistance in medium to highly acidic environments. Skvara et al, U.S. Pat. No. 5,076,851. MIXED GYPSUMLESS PORTLAND CEMENT. Skvara et al describe blended gypsum free Portland cement with granulated slag or fly ash, activated using alkali metal carbonate in the presence of wetting agents. All the components are inter-ground. Note: this patent is mentioned as an example of alkali activated blended cements as background information. The described cement system is only border-line related to the current invention by using slag in the mixture and alkali activation. It does not have the high acid resistance of described invention, since it contains a high amount of calcium oxide.

Mallow, U.S. Pat. No. 5,352,288. LOW-COST, HIGH EARLY STRENGTH, ACID RESISTANT POZZOLANIC CEMENT. Mallow describes a cement composition that can be mixed with water and hydro-thermally cured to give acid-resistant products of high compressive strength consisting essentially of, in parts by weight, 1 to 1.5 parts of a calcium oxide material containing at least about 60% CaO, 10 to 15 parts of pozzolanic material containing at least about 30% by weight amorphous silica, and 0.025 to 0.075 parts by weight of an alkali metal catalyst and building materials made from the described composite. Note: It will be shown that the presence of calcium oxide (hydroxide) component reduces the acid resistance, particularly in sulfuric acid. Also the compositions need to be hydro-thermally cured.

Blaakmeer, at al U.S. Pat. No. 5,482,549. CEMENT, METHOD OF PREPARING SUCH CEMENT AND METHOD OF MAKING PRODUCTS USING SUCH CEMENTS. Blaakmeer et al describe dry cement mixture, which comprises ground blast-furnace slag having a specific surface area of 500-750 m²/kg and ground fly ash having a specific surface area of 500-750 m²/kg, in a weight ratio in the range of 20/80-70/30, and further comprises the following components in the amounts indicated, calculated on the total mixture: at least 2% by weight of Portland cement clinker and 2-12% by weight of sodium silicate (calculated as Na₂O+SiO₂). When mixed with water, the cement mixture yields a mortar or a concrete with improved strength properties and good resistance against an acidic environment. Note: This patent does not distinguish between C and F Fly Ash. It will be shown that it is important to minimize the calcium oxide (hydroxide) in the mixture to achieve a high acid resistance, particularly in sulfuric acid. This is achieved by using only F Fly Ash and minimizing the slag, since slag contains a considerable amount of calcium oxide.

Liskowitz at al, U.S. Pat. No. 5,772,752. SULFATE AND ACID RESISTANT CONCRETE AND MORTAR. Liskowitz et all describe concrete, mortar and other hardenable mixtures comprising cement and fly ash for use in construction and other applications, which hardenable mixtures demonstrate significant levels of acid and sulfate resistance while maintaining acceptable compressive strength properties. The acid and sulfate hardenable mixtures of the invention containing fly ash comprise cementitious materials and a fine aggregate. The cementitious materials may comprise fly ash as well as cement. The fine aggregate may comprise fly ash as well as sand. The total amount of fly ash in the hardenable mixture ranges from about 60% to about 100% of the total amount of cement, by weight, whether the fly ash is included as a cementitious material, fine aggregate, or an additive, or any combination of the foregoing. In specific examples, mortar containing 50% fly ash and 50% cement in cementitious materials demonstrated superior properties of corrosion resistance. Note: this patent describes compositions with a high amount of calcium oxide by using 50% of Portland cement and unspecified fly ash, which may also include a high amount of calcium oxide (hydroxide).

Shi, U.S. Pat. No. 6,749,679. COMPOSITION OF MATERIALS FOR PRODUCTION OF ACID RESISTANT CEMENT AND CONCRETE AND METHODS THEREOF. Shi describes a cement composition with acid resistance containing liquid alkali silicate, vitreous silicate setting agent, lime containing material and inert filler. The patent also describes building materials made from the compositions and the method of making such building materials. The liquid alkali silicate may include sodium silicate or potassium silicate. The vitreous silicate setting agent may include soda-lime glass powder or coal fly ash. The lime containing material refers to the materials containing more than 20% lime and may include quicklime, hydrated lime, Portland cement, blast furnace slag or steel slag. The inert fillers include ground quartz, ground ceramic, and/or clay. Note: this patent also includes a high quantity of calcium oxide(hydroxide) components, contained in lime, quicklime hydrated lime, Portland cement and blast furnace slag. This reduces the acid resistance, particularly resistance to sulfuric acid.

Timmons U.S. Pat. No. 7,442,248. CEMENTITIOUS COMPOSITION. Timmons shows pozzolans in mixtures with Portland cement, to increase their effectiveness. Note: the patent does not show or makes any reference to acid or a high temperature resistance of these compositions. The hollow glass cenospehers in this patent are used as a lightweight filler, next to other types such polymer microspheres, vermiculite, expanded perlite, expanded polystyrene, expanded shale or clay, synthetic lightweight aggregate, and combination thereof.

Skvara, Allahverdi, Czech patent 291 443. GEPOLYMERIC BINDER. The patent describes a geopolymer binder consisting of 35.01-93.9% of ash; 0-40% Portland cement or slag, 5-15% sodium or potassium silicate with SiO₂/Na₂O (or K₂0) ratio 5-15% and 1.1-9.9% Aluminum compound, containing minimum 35% of Al₂O₃ equivalent. Note: the patent includes Portland cement and slag. Both would reduce chemical resistance in acid environment. The disclosure states that higher strengths can be achieved only with fly ashes containing higher amounts of calcium oxide, indicating that the fly ash used contains a higher amount of calcium oxide, reducing the acid resistance as already stated.

Skvara & Kastanek, Czech patent 292875. GEOPOLYMERIC BINDING AGENT BASED ON FLY-ASHES. The patent does not distinguish fly ashes between F and C class and includes calcium containing compounds such as calcium carbonate, calcium magnesium carbonate, anhydrite calcium sulfate and di-hydrate calcium sulfate and many other calcium containing compounds. Note: The calcium containing compounds, such as C fly ash and all other calcium compounds included in the patent reduce acid resistance, mainly in sulfuric acid.

Svoboda at al, Czech patent application 2004-536. FLY ASH CONCRETE AND PROCESS FOR ITS PREPARATION BY GEOPOLYMERIC REACTION OF ACTIVATED FLY ASH AND USE THEREOF. The application does not indicate the ash classification in respect to calcium compounds contained in the ashes. It includes the addition of slag and calcium compound as well as aluminum hydroxide as set retarder. Note: The need for set retarder indicates that the patent describes the activated fly ash binder with relatively high content of calcium containing material, the presence of which, as described in this disclosure, reduces the acid resistance of the composition.

Sulc R. et al, Czech patent application, 2007-269. FLY ASH-BASED CONCRETE. The patent describes fly-ash based concrete, with absence of Portland cement. But as in the Czech patent 291 443 it is describing binders with a relatively high content of calcium oxide. Note: the patent states that it is advantageous to use fly ashes with calcium oxide content higher than 8%. The patent does not give any information on the calcium oxide content used in the examples given, but the incorporation of aluminum hydroxide as a retarder of the fast initial set show the high calcium oxide content in the fly ashes used. Also, the high compressive strengths achieved in the example mixes given in the patent, show that a relatively high amount of calcium oxide fly ash must have been used.

PATENT REVIEW—Temperature Resistance. Mallow, U.S. Pat. No. 4,030,939. CEMENT COMPOSITION. Mallow describes a cement composition consisting of the product of a mixture of spray-dried hydrated silicate powder, a silica polymer-forming agent and water. The resulting inorganic silica polymer cement is capable of withstanding sustained exposure to high temperatures without loss of desirable mechanical properties and has a high degree of adhesive as well as compressive strength together with rapid room temperature curing characteristics. A siliceous filler may be added. In addition, a fluoride or halide fixation agent may be added so that the resulting cement product may resist higher temperatures. Note: the patent claims without explanation that the dry sodium silicate powders provide a high degree of fluidification which results in small water demand for obtaining castable mixes. The examples show a high temperature resistance up 804° C. The chemical resistance of materials provided in the examples is not provided. The high temperature resistance of the materials described in the patent is due to polymerization of the silicate by the presence of sodium or potassium silico fluoride. This patent is not based on F Fly ash or F Fly ash combined with slag, it is only border-line related to this disclosure and is mentioned as a reference, since it uses potassium and sodium silicates in a high temperature resistant cement composition.

Ivanov et al, U.S. Pat. No. 4,035,545. HEAT RESISTANT POROUS STRUCTURAL MATERIAL. Ivanov describes a material, comprising 50-75 volume percent of microspheres of high-melting point oxides, sintered directly with each. The diameter of said microspheres ranges from 10 to 200 mu. The diameter of contact of said sintered microspheres amounts to 0.2-0.5 of said microsphere diameter. The present invention enabled an enhancement of recrystallization resistance, strength and deformability of said heat-resistant porous structural material. Thus, a material made of microspheres of stabilized zirconium oxide, 30-40 mu in diameter, with a contact diameter equal to 0.3 of the microsphere diameter and a 30% porosity exhibits a compression strength of 6000 kg/cm.sup.2, a tensile strength of 500 kg/cm.sup.2 and 0.01 elongation at room temperature, which constitutes a 5-10-fold increase, as compared with the corresponding characteristics of the known granular materials of a similar composition. Note: the microspeheres mentioned in this patent are not “cenospeheres” and the process used in fabrication of such composite is heat sintering, not alkali activation in water borne mixes.

Laney et al. in the U.S. Pat. No. 5,244,726. ADVANCED GEOPOLYMER COMPOSITES. Laney describes a self-hardened, high temperature-resistant, foamed composite is described. An alkali metal silicate-based matrix devoid of chemical water has dispersed therein inorganic particulates, organic particulates, or a mixture of inorganic and organic particulates, and is produced at ambient temperature by activating the silicates of an aqueous, air-entrained gel containing matrix-forming silicate, particulates, fly ash, surfactant, and a pH-lowering and buffering agent. Note: the patent is based on kaolinite clays geopolymer matrix, activated using alkali metal silicates. Wetting agents are used to help incorporation of various fillers such as expanded polystyrene beads and polymeric fibres. The invention uses fly ash without specific description as a thickening agent. At high temperatures the expanded polystyrene beads or polymer fibers melt and vaporize without reducing the thermal insulation characteristics of the composite. The patent does not cover alkali activation of F-Fly ash or slag and their combinations as the present disclosure shows, and the patent is mentioned only as a borderline reference.

Barlet-Gouedard et al, U.S. Pat. No. 7,449,061. HIGH TEMPERATURE CEMENTS. Barlet-Guedard describes high temperature cement slurries based on Portland cement. The slurries are intended to be used at temperatures s from 250° C. to 900° C. The high temperature resistance is achieved by additives contributing silicon, calcium and alumina oxides, so the mineral composition lie in the xonotlite/wollastoniite, grossulair-anthorite-quartz triangle of the Alumina, Calcium and Silica phase diagram. By adding heat resistant aggregates, iron and magnesium oxides and cenospheres the temperature resistance is also improved. The patent also shows the use of particle packing on the flow of slurry compositions and their densification. The main function of cenospeheres is to release the pore pressure created by water vapor escaping from hydrated calcium silicates at elevated temperatures. Note: the patent is based on Portland cement, resulting with low acid resistance of the described compositions.

Barlet-Gouedard et al, U.S. Pat. No. 7,459,019.CEMENT COMPOSITIONS FOR HIGH TEMPERATURE APPLICATIONS. In this patent Barlet-Guedard further expands the U.S. Pat. No. 7,449,061 by additional additives based on alumina and silica oxides modifiers. Note: the same argument as above, about low acid resistance of Portland cement based composition, applies.

Tobin, U.S. Pat. No. 4,016,229. CLOSED-CELL CERAMIC FOAM MATERIAL. Tobin teaches the use of cenospeheres (glass micro-balloons and fly ash cenospheres) in formation of closed-cell ceramic foam by application of heat. The firing is done at the temperature starting at 93° C. to 315° C., over a period 6-8 hours, then heating cenospheres from about 1354° C. to 1650° C. for 0.25 to 1.5 hours. The high temperature sinters the cenospheres into a lightweight mass with density approximately 0.49 g/cm³. Tobin also shows the use of a temporary organic binder to form the cenospheres to predetermined shape before sintering. Note: this patent is based on sintering cenospheres at high temperatures. The patent does not use alkali activated fly ash and or slag as binder

Anshits et al, U.S. Pat. No. 6,444,162 and 6667261.OPEN-CELL CRYSTALLINE POROUS MATERIA. Anshits describes an open-cell glass crystalline material made from hollow microspheres, obtained from fly ash. The cenospehers are molded and agglomerated by sintering with a binder at a temperature below the softening temperature of the cenospheres, or without a binder at temperatures about or above the softening point, but below the melting point. As the binder the authors mention liquid glass and water as a wetting agent, without any further description as to the type of liquid glass. The mixture is dried at temperature of 160° C. for two hours and is sintered at temperatures above 800° C. for 0.5-1.0 hours. The other method sinters the cenospheres at temperature of 1000-1100° C. The patent utilizes two types of cenosphers—perforated and non-perforated. The perforation is described as etching of the microspheres, by hydrochloric, hydrofluoric acids or fluoride compounds which form micro-holes in the cenospheres. The “perforted” microspheres are used for the lower temperature sintering, the non-perforated for the higher temperature sintering. The chemical resistance data are given only for nitric acid in 3, 6, 9 and 12 molar solution at temperatures of 20, 40 and 60° C. The material in this range of nitric acid concentrations has exhibited the weight loss less than 1%. The claimed density is 0.3-0.6 g/cm³ and compressive strength 1.2-3.5 MPa. The porous material of this invention has properties useful as porous matrices for immobilization of liquid radioactive waste, heat resistant traps and filters, supports for catalysts, adsorbents and ion-exchangers. Note: this patent is based on sintering cenospheres at high temperatures. The patent does not use alkali activated fly ash and or slag as binder.

Godeke, U.S. Pat. No. 6,805,737. LIGHTWEIGHT SUBSTANCE MOLDED BODY, METHOD FOR THE PRODUCTION AND USE THEREOF. Godeke describes lightweight substance bodies made of lightweight aggregate and a sintering auxiliary agent. As lightweight aggregate is selected from a group of materials consisting expanded glass, scrap glass and their mixtures. As sinteric agent the claimed mixtures use alkali silicate solutions. The molded bodies are produced by mixing materials, casting and sintering at temperature from 400° C. to 1,000° C. over a period of 0.1 to 5 hrs. The typical densities of sintered products vary from 150 to 750 kg/m³. The compressive strength varies from 0.1 N/mm² to 15 N.mm² depending on density. Note: Godeke used alkali metal silicate as a binder for lightweight aggregate and sintering at high temperatures. Present disclosure used a alkali activated binders and no sintering, just elevated temperature, 80-100° C. steam curing.

Timmons, U.S. Pat. No. 7,442,248. CEMENTITIOUS COMPOSITION. Timmons presents cementitious compositions comprising of pozzolonic materials, alkaline earth metals, and a catalyst to catalyze the reaction between the pozzolonic materials and the alkaline earth metals. The patent describes pozzolans in mixtures with Portland cement, to increase their effectiveness. Note: The patent does not show or makes any reference to acid or a high temperature resistance of these compositions. The hollow glass cenospehers in this patent are used only as a lightweight, filler, next to other types such polymer microspheres, vermiculite, expanded perlite, expanded polystyrene, expanded shale or clay, synthetic lightweight aggregate, and combination thereof.

Chatteji et all, U.S. Pat. No. 7,413,014. FOAMED FLY ASH COMPOSITIONS AND METHODS OF CEMENTING. Chatterji discloses methods of cementing and low density foamed cement compositions. A low density foamed cement composition of the invention comprises of C fly ash comprising calcium oxide or calcium hydroxide, water present in an amount sufficient to form a slurry, a foaming and foam stabilizing surfactant or a mixture of surfactants present in an amount sufficient to facilitate foam and stabilize the foamed cement composition, and sufficient gas to foam the foamed cement composition. Note: This patent covers foam cement materials with no chemical resistance in acid environment and no temperature resistance as described in the present disclosure. It is presence of calcium anions which do not allow the acid resistance. The hydration products of C Fly ash and calcium hydroxide exhibit even lower temperature stability when compared with hydrated cement paste. The current application does not use C Fly ash. It is uses only F Fly ash or F Fly ash in combination with finely ground slag.

Dattel, Clinton D., U.S. Pat. No. 6,485,561 2002. INORGANIC FOAM BODY AND PROCESS FOR PRODUCING SAME. Compositions and methods are provided for creating a low density cellular concrete that has a viscosity which rapidly increases after adding an accelerator, while maintaining substantially the same density. The initial components include a cement, water, a surfactant to create foam, and an accelerator such as sodium carbonate. The accelerator serves to rapidly increase the viscosity of the mixture, thereby entrapping the foam or air within the matrix of the mixture-before air can escape. An additional embodiment includes using a byproduct such as fly ash in the composition to further reduce costs and make an environmentally friendly product. Note: The above disclosure describes modified Portland cement or Portland cement with addition of fly ash. The invention uses set accelerators such as sodium carbonate or bicarbonate and a non-ionic surfactant to form foam on mixing the above described mixture. The composition, according to the disclosure may also contain sand, silica fume cenospheres, fibres and water reducing agents. The above described compositions are based on Portland cement, hence they have the limited resistance to elevated temperatures and no resistance to acids.

Giesemann, Herbert, U.S. Pat. No. 5,298,068. INORGANIC FOAM BODY AND PROCESS FOR PRODUCING THE SAME. The inorganic foam body consists of an at least partially open-cell foam formed by thermally foaming and hardening a mixture comprising an alkali water glass and a filler from the group of aluminum oxide, silicon dioxide, aluminous cement, crushed rocks, graphite or mixtures thereof. It is produced by heating a mixture comprising an alkali water glass and a tiller from the group of aluminum oxide, silicon dioxide, aluminous cement, crushed rocks, graphite with a blowing agent, and preferably azo-dicarbonamide, at temperatures of at least 180° C. and preferably from 200° C. to 300° C. C. The foam body has a bulk density within the range of from 50 to 500 kg/m³, and preferably of from 50 to 400 kg/m³. Note: The Giesman's invention describes material where the alkali silicate is the binder filled with the aluminum oxide, silicone dioxide. The lightweight composition is formed by heating the mixture to at least 180° C. at which the nitrogen gas forming azo-compound forms the cell structure within the binder. The present disclosure is based on F Fly ash or F-Fly ash combined with finely ground slag, chemically activated by alkali silicate and alkali hydroxides at ambient temperatures or at temperatures not exceeding 80-100° C.—steam curing.

Lukancuk, John S., U.S. Pat. No. 4,960,621. METHOD OF INSULATING WITH INORAGNIC-NON COMBUSTIBLE FOAMS. A method of applying an inorganic non-combustible foam making use of separately packaged sodium silicate as a liquid and a mixture of sodium silico-fluoride, silicon metal and a filler. Note: This patent is based on foaming the sodium silicate, filled with wollastonite and perlite, using silicone metal. The silicon acts as a forming agent, by generating hydrogen gas on mixing with highly alkali environment of sodium silicate.

Ritzer et al, U.S. Pat. No. 4,504,320

A glass-fiber reinforced light-weight cementitious product having a density of less than 85 pounds per cubic foot, a high tensile strength and a high compressive strength, when cured, and hence, suitable for structural articles in which such properties are required. The product is formulated from a mixture in which the aggregate comprises substantially equal parts by weight of fly ash cenospheres and silica fume. Note: The above described compositions are based on Portland cement. They contain a high amount of cenospheres as lightweight filler and chopped alkali resistant glass fiber. The compositions, being based on Portland cement, does not exhibit acid resistance, high temperatures any other Portland cement based mixtures.

### DISCLOSURE OF THE INVENTION

The above mentioned drawbacks are significantly eliminated by the acid and high temperature resistant cement composites, according to this invention. The matrix is F fly ash particles ranging from <1 micron to 150 microns and/or ground slag contains around 30% by weight of calcium oxide alkali, activated by sodium or potassium hydroxides in combination with alkali metal silicates. The concentration of potassium or sodium hydroxides varies from 3.0% to 15.0% by weight, based on the weight of the matrix (binder), defined as the weight of F-Fly ash alone or F-Fly ash in combination with ground slag. The concentration of liquid sodium or potassium silicate varies from 3-30% by weight, based on the liquid sodium or potassium silicates, containing 8.9% Na₂O or K₂O and 28.7% SiO₂, this based on the weight of the matrix (binder), defined as the weight of F-Fly ash alone, or in combination with ground slag. When using solid sodium or potassium silicates, the typical content varies from 1% to 15% by the weight of the matrix (hinder), this based on the weight of the matrix (binder), defined as the weight of F-Fly ash alone, or in combination with ground slag. The solid sodium or potassium silicates contain 19% Na₂O or K₂O and 61% of SiO₂.

An advantage is in using in the composition un-densified silica fume—condensed silica fume, the amorphous silicone dioxide obtained as by products in production of ferro-silicones, the amount of silica fume—condensed silica fume, varies from 0 to 30% by weight, by the weight of the matrix—binder). Precipitated nano-particle silica made from soluble silicates and nano-particle silica fume produced by burning silicon tetra chloride in the hydrogen stream, whereas quantity of fume silica varies from 0 to 5% by the weight of the binder.

An additional part of the composite are the fillers as silica sand for mortars for incorporation of sand ad stone fillers results in composite densities from 2.2 g/cm³ to approximately 2.45 g/cm³. Contains agents based on poly-carboxylates. Using hydrophobic particles such as silane treated fume silica or other hydrophobic, typically silicone dioxide particles. Using mathematical modeling, minimizing the free inter-particle space (porosity) of different-distributions.

The cement systems is heated to temperatures up to 80-100° C. by steam curing. The matrix is combined with cenospheres or with other lightweight aggregates from the group of perlite, expanded shale and clay can be used Cenospheres are hollow ceramic microspheres, their specific density varies typically from 0.3-0.8 g/cm³. Cenospheres have a particle size range of 10-600 micron and contain typically 56-64% of SiO₂ and 28-35% of Al₂O₃. The matrix is combined with porous recycled glass particles different particle size grades varying from 0.1 to 8 mm.

It specifies the use of F-Fly ash, F-Fly ash in various combinations with ground blast furnace slag, or ground slag alone. The lower the calcium oxide content in the mix, better is the acid resistance to acids, specifically to sulfuric acid. If only F Fly ash is used as binder the resistance to sulfuric acid is the highest. The addition of slag with F-Fly ash reduces the resistance to sulfuric acid. But even pure alkali activated ground slag, which contains calcium oxide, has a considerably higher resistance to acids when compared with conventional Portland cement based composites. The addition of addition of ground slag to F-Fly has benefits, even though it may reduce the resistance to sulfuric acid to some degree (will be shown on examples). Slag reduces the permeability of the composite to penetration of acids, increases the strength and speeds up the strength development. The effective way in increasing the alumina content in F-Fly ash mixes, while keeping the very low calcium ion content of the F-Fly ash is achieved by adding calcined aluminum silicates and or aluminum hydroxide.

The cement binder (alkali activated F-Fly Ash or F-Fly Ash with ground slag and ground slag alone) exhibit high temperature resistance with a high specific density filler such as silica sand. The temperature resistance is improved and heat transfer is reduced and the heat dissipation improved by using the above described lightweight fillers, including entrained air and preformed foam. The lightweight fillers can reduce the specific gravity to values around 1.0 g/cm³. For densities below the normal density of 2.2 g/cm³ the high level of air entrainment—air cell formation on mixing, will also reduce the specific densities down to values around 1 g/cm³.

The further decrease in specific is achieved by combining the above described matrix in its slurry—liquid, state with preformed foam. The preformed foam is generated in a foam generator, where a suitable surface acting agent is blended with water and air, forms foam, which is then mixed with the slurry. The particles size distributions of the reactive particles and fillers are combined using a particle packing mathematical model to achieve the maximum filling of inter-particle spaces. Fracture toughness, bending/tensile strengths and drying shrinkage cracking is controlled by fibre reinforcement. Rheology of the mixes is controlled by inorganic thixotropic admixtures, e.g. bentonite or modified betonite clays. The rheology can be adjusted to allow self-leveling characteristics for horizontal applications or casting applications, or sufficient cohesion to allow application to vertical surfaces. The high slag content mixes exhibit fast “false” set. This set can be controlled in several ways: using retarders such as citric acid, sodium citrate, tartaric acid and sodium tartarate, or other organic acid compounds. Another method of controlling the set is in increasing the amount of F-fly Ash in the F-Fly ash-slag mixture. An important way of extending the “open time” of the mixes is to use solid sodium silicate instead of solutions.

### Fly Ash

Fly-ash is a by-product of coal burning in thermal power plants. Fly-ash is s fine particulate residue removed from the gas stream before by a dust-collection system, before the gas stream is removed into the atmosphere. Fly-ash particles are typically spherical, ranging from <1 micron to 150 microns. The chemical composition of fly ash is determined by the chemical composition of the burning coal and comprises of silicon, aluminium, iron, calcium and magnesium element. Fly ash obtained by combustion of sub-bituminous coals contains more calcium and iron than fly ash from bituminous coal. Depending on the type of coal particles and rate of combustion the fly ash also contains a varying degree of carbon particles. Canadian Standards Association (CSA) and ASTM (American Society for Testing of Materials) recognized two classes of fly-ash:
Class C, normally produced from lignite or sub-bituminous coals; and
Class F, normally produced from bituminous coal

Class C fly ash contains a high level of calcium and as result it has self-hardening capacity on addition of water. F-Fly ash contains only a very low level of calcium, and it is not self hardening on addition of water. In France, fly ashes are classified into three groups: the silico aluminous group, which corresponds mainly to ASTM Class F, silicocalcic group which corresponds mainly to ASTM Class C, and sulfocalcic group, which has high calcium and high sulfur contents.

### Ground Slag

Slag, or ground blast furnace slag, is the by-product of the manufacture of pig-iron in a blast furnace. The impurities contained in iron ore and coke become part of the blast furnace slag. The resulting chemical composition stays within very definite area of the SiO₂—CaO—Al₂O₃ phase diagram. From a chemical point of view it has quite constant composition. Slag can be cooled in two ways. It can be left to cool slowly and so it crystallizes mainly in form of melilite, a solid solution ackermanite and gehlenite. When cooled in such a way it has practically no hydraulic value (it does not harden when mixed with water), even when finely ground. It is used only as a non-reactive aggregate in concrete and asphalt. When slag is quenched when it comes out of the blast furnace, it solidifies in a vitreous form and becomes reactive if properly ground and activated. There are three way of quenching the molten slag:

1. slag is poured into a water basin where it disintegrates into a form of coarse sand referred to as “granulated” slag;
2. slag is quenched by powerful water jets also forming “granulated” slag;
3. slag is quenched by combination of water and air stream, forming so called “pelletized” slag. This type is used as lightweight aggregate, or it can be ground to make a cementitious powder.

The key characteristic for using slag is its hydraulic property closely related to its vitreous state. If the slag temperature was somewhat low on quenching, the melilite crystals may be present and the slag is less reactive when compared with of slag which is more vitreous by quenching at higher temperature. Well-quenched, “hot” slags have a pale yellow, beige of grayish color, while “cold” slags color varies from dark grey to dark brown. For the purpose of this application we are mainly interested in and will be using only the ground “hot”, the lighter color slags.

### Cenospeheres

Cenospheres are hollow ceramic microspheres, filled with air or gas, typically produced as a by-product of coal burning thermal power plants at temperatures 1,500 to 1,750° C. When pulverized coal is burned at power plants fly ash is produced. The color of cenospheres obtained from burning pulverized coal, varies from gray to almost white and their specific density varies typically from 0.3-0.8 g/cm⁻¹. Cenospheres have a particle size range of 10-600 micron and contain typically 56-64% of SiO₂ and 28-35% of Al₂O₃. Cenospheres are hard and rigid, light, waterproof, innoxious, and insulative. Most cenospheres are obtained from ash ponds. Ash ponds are final storage for fly ash when wet disposal is carried out. Some cenospheres are also collected at the power plants themselves. The wet microspheres are dried and processed to specifications. The properties of cenospheres depend on the consistency of the coal used and the operating parameters of the power plant. As long as these two factors remain constant, the chemical and physical properties will be quite consistent. Cenospheres can be also produced by burning oil, asphalt or thermoplastic fuel droplets. These types of cenospheres, burned at much lower temperatures than the ceramic cenospheres, are often called “fuel” cenospeheres and are always black. For the purpose of this application we are dealing only with so called ceramic cenospheres, hollow particles of light colors.

### Porous Glass Particles

Porous glass particles are made of recycled glass. The recycled glass is ground into fine glass flour in large mills. After adding water, a binder and an expanding agent, the round shape occurs in the granulation process. The granules are then expanded in a rotary kiln at 900° C. The expanding process gives rise to finely-porous, creamy-white spherical particles with cellular structure within the particle. After the cooling process particles are screened and sorted by grain sizes. The porous glass particles are available in different particle size grades varying from 0.1 to 8 mm. In respect to the particle size the corresponding crushing strength (in compression) varies from 400 psi to 180. The main chemical component is SiO₂ (71-72%) and Na₂O (13-14%), with small content of Al₂O₃ (2-3%) and CaO (8-9%). The specific densities vary from 0.3-1.1 g/cm³ and from 1.0-1.85 g/cm³ depending on the type and the manufacturer. Some manufacturers offer grades up to 25 mm in size. The smaller grades are typically used in Portland cement renders, in manufacturing a lightweight cement block and as an aggregate in polymer concrete. Larger aggregates are used as a lightweight aggregate in concrete.

### Expanded Shale and Clay Particles

Expanded shale or clays are lightweight aggregates prepared by expanding selected shale or clay in a rotary kiln at temperatures over 1000° C. At these temperatures, the minerals soften and begin to melt. Meanwhile, the reactions to the heat from certain constituents produce gasses, creating non-connecting cells in the vitrified material. The resulting material is cooled and is crushed and screened to control gradation, which varies depending on intended use. The expanded clay and shale particle are typically supplied in particle sizes varying from 5 to 12 mm. The chemical composition depends on the chemical composition of the source shale or clay. The typical chemical components of a good quality expanded shale aggregates are: SiO₂ (57-59%); Al₂O₃ (18-21%), CaO (3-5%), Na₂O (5-7%). The expanded shale or clay aggregates are used in production of lightweight structural concrete and mortars. This aggregate is also used in manufacturing of concrete blocks.

### Preformed Foam

Preformed foam is generated in so called “foam generator” using compressed air, water and foaming surface acting agents. The typical density of the preformed foam is 13 gram/L. The typical foaming agents used to generate preformed foam can be generically divided into two types: so called “modified natural (animal) proteins or synthetic foaming agents. While various foaming and foam stabilizing surfactants can be utilized in accordance with this application, a particularly suitable surfactants comprises of synthetic surface acting agent commercially available from Gemite Products Inc. under the trade designation Lite-Con. The preformed foam is generated by combining air under pressure and the surfactant mixture in water. The typical concentration of the admixture in water is 20 to 40 parts of surfactant to water. Other foaming and foam stabilizing surfactant are available and can be utilized in accordance with the present invention

### Air Cell Formation on Mixing

The densities from regular densities of 2.2 g/cm³ down to approximately 1 g/cm³ is also achieved by introducing the air cell structure into the slurry during mixing by adding suitable foaming agents. There is a large number of compounds that can be used for this purpose. These are Sodium Alpha Olefin Sulfonates, Alkyl sulfates, Alkyl Ether sulfates, modified natural proteins, synthetic proteins. The typical cases of matrix with air cell formation achieved on mixing are described in detail in examples given below.

### Gas Generating Reactions

There is a large number of compounds that can be used for lowering the specific density of the described matrix by generating gas as result of chemical reaction between the compound and the high pH of alkali activated cement systems. The number of these has been described in patent literature. The typical example for nitrogen gas forming is described in the U.S. Pat. No. 5,298,068 by Giesman. The patent describes formation of foamed inorganic body made of sodium silicate and aluminum oxide using azodicarboamide at temperatures between 180-200° C. The decomposition of azodicarboamide forms nitrogen gas forming the lightweight inorganic material. An alkali activated silicate foamed concrete is described in the U.S. Pat. No. 5,605,570 by Bean and Mallone, in which the decomposition of sodium peroxide forming oxygen is used to form lightweight cement from calcium rich glassy silicates, e.g. slag. The most commonly used compound in production autoclaved cellular concrete is alumina. The basic raw materials are Portland cement, limestone, aluminum powder, water, and a large proportion of a silica-rich material-usually sand or fly ash. Once raw materials are mixed into slurry and poured into mold, the aluminum powder, during autoclaving at elevated temperature and pressure, reacts chemically to create tiny hydrogen gas bubbles, forming a lightweight construction material. The alumina powder is also suitable for producing lightweight composites described in examples of this disclosure.

### Particle Packing

In alkali activated cement system, as in any other particle systems, the particle packing is important for reducing permeability to acid solutions and increasing compressive strength. Mathematical modeling is used obtaining the minimum porosity or “free space” in the particle blends. In formulating the alkali activated cement blends, described in this disclosure the mathematical model developed by James S Funk and Dennis R. Dinger and described in “Predictive Process Control of Crowded Particulate Suspensions”. The model is based on the D-F particle distribution equations and the software developed by the same authors calculates the porosities of various blends, based on the particle distribution of individual components of the blend, in which each blend component has its own particle distribution. Component particle distributions are obtained by sieve analysis, laser analysis or gas absorption for the smallest particles. Determination of the minimum porosity particle blends is very important in the fine particle sizes. Maximizing the particulate packing is essential in minimizing the permeability of the system and maximizing the compressive strength.

### EXAMPLES OF THE DESIGN OF THE INVENTION

The alkali activated cement composites are based on F-Fly or ground slag as a binder in various combinations, from 100% F-Fly ash to 100% ground slag. The sodium or potassium hydroxides in combination with alkali metal silicates, typically sodium silicate, are used to alkali activated the binder. The concentration of potassium or sodium hydroxides varies from 3.0% to 15.0% by weight, based on the weight of the matrix (binder), defined as the weight of F-Fly ash alone or F-Fly ash in combination with ground slag. The concentration of liquid sodium or potassium silicate varies from 3-30% by weight, based on the liquid sodium or potassium silicates, containing 8.9% Na₂O or K₂O and 28.7% SiO₂, this based on the weight of the matrix (binder), defined as the weight of F-Fly ash alone, or in combination with ground slag. When using solid sodium or potassium silicates, the typical content varies from 1% to 15% by the weight of the matrix (binder), this based on the weight of the matrix (binder), defined as the weight of F-Fly ash alone, or in combination with ground slag. The solid sodium or potassium silicates contain 19% Na₂O or K₂O and 61% of SiO₂.

Both, dry or liquid sodium or potassium silicates can be used. In compositions of higher slag content, typically above 50% of slag, false set may occur, depending on the specific chemistry of F-Fly ash and slag, water binder ratio and specific alkali activated cement composition. This set can be controlled in several ways: using retarders such as citric acid, sodium citrate, tartaric acid and sodium tartarate, or other organic acid compounds. Another method of controlling the set is in increasing the amount of F-fly Ash in the F-Fly ash-slag mixture. An important way of extending the “open time” of the mixes is to use solid sodium silicate instead of solutions

The important part is condensed silica fume (CSF). CSF acts as filler as well as reactive material. The amount of condensed silica fume varies from 0% to 30% by weight, by the weight of the matrix (binder). The amount of CSF needs to be selected I such a way that it only fills the free space between the binder particles. The smaller amounts are not sufficient to fill the free inter-particle space, and the excessive amount separates the reactive particles of the binder. In both cases, insufficient as well as excessive amounts reduce the composite strength and increase porosity. The correct amount of CSF can be calculated using mathematical particle packing model, from known particle distribution of F-Fly ash, slag and CSF or can be determined experimentally.

An addition of nano-particle sized fume silica in small quantities provides filing of minute inter-particle spaces and also accelerates the chemical activation process. The typical quantity of fume silica varies from 0 to 5% by the weight of the binder. An additional part of the composite are the tillers. These can be silica sand for mortars. The incorporation of coarser aggregate into the mortar forms concretes with the alkali activated binder in lieu of Portland cement or other types of cement binders. The incorporation of sand ad stone fillers results in composite densities from 2.1 g/cm³ to approximately 2.45 g/cm³.

The reduction of the composite density is achieved by incorporation of lightweight aggregates in the alkali activated cement binder. The preferred lightweight aggregates are cenospheres and lightweight aggregate made of waste glass. Any other inorganic lightweight aggregate from the group of perlite, expanded shale and clay can be used. Depending on the amount of the lightweight aggregate, used in the composition the specific density can be varied from approximately 2.1 g/cm³ to approximately 1.0 g/cm³. Another method of reducing composite density is incorporation of preformed foam into the binder. The pre-formed foam is produced in a foam generator using water, compressed air and a suitable surface acting agent. The typical density of the preformed foam is 13 g/L. Typical quantities of preformed foam varies from 0% to 20% by the weight of the matrix (binder), and the densities are reduced down to 0.2 g/cm³. The low density composites from approximately 2.2 to 1.0 g/cm³ can be also achieved by adding surface acting agents entraining air during mixing. The amount of the foaming agent vary on the actual composition of the mix, type of the surface acting agent used and the desired density All three methods, addition of the lightweight filler, preformed foam and mix added foaming agent can be combined to obtained desired density and strength properties of the composite. Minimizing of water content in the mix is essential for maximizing strength, reducing permeability and shrinkage. Conventional water reducing agents used in concrete technology based on polycarboxylates, sodium salt of melamine formaldehyde condensates are used to achieve the water reduction.

Introduction of hydrophobic silica particles such as hydrophobic fume silica, hydrophobic precipitated silica or other hydrophobic inorganic particles increases the resistance of the composite to absorb water and acid solutions. This is important in formulating thin, several millimeters, coatings for protection of concrete or steel against acids.

Fiber reinforcement has number of functions: it reduces drying shrinkage induced cracking and also increases fracture toughness of the composite. The following organic type of fibers can be used: cellulosic fiber and polymeric fibers such as acrylic, polypropylene and others. Inorganic fibers include natural wollastonite fiber, man-made fibers made of basalt, carbon or graphite fibers.

Defoamers. The incorporation of water reducing agent in some mixes may introduce air. In high density mortars and concrete, or in thin coating application, this entrain air is not desirable, since it may increase the permeability of the composite. An addition of defoamer reduces or eliminates the entrained air. The conventional deformers base on mineral hydrocarbons, or silicones can be used for this purpose.

Rheology modifiers. The described composite exhibit a free flow, almost self-leveling characteristics. These are suitable for application of these materials to horizontal surfaces, such as floor slabs or in casting into molds. In application to vertical surfaces, thixotropic, the non-sag rheology of the mixes is required. This can be achieved by modifying the mixes with unmodified or unmodified bentonite clays, fume silica, precipitated silica or derivatives of methyl, or ethyl cellulose, or starch compounds. All compositions described in this disclosure exhibit better acid resistance than Portland cement concrete. The actual chemical resistance depends primarily on the ration of the F-Fly ash and Slag. The highest acid resistance is achieved by compositions containing no slag, just F-Fly ash. The fast setting characteristic of composites containing a high content of slag are controlled y addition of retarders. Also, the aluminum content in compositions containing a high amount of F-Fly ash can be increased by addition of calcined aluminum silicate or aluminum hydroxide.

Note: sodium silicates used in the following examples are:

Sodium silicate N solution, manufactured by National Silicates: 3.22 weight ratio of silicone dioxide over sodium oxide, 37.5% solution in water. Dry sodium silicate G, manufactured by National Silicates: 3.22 weight ratio of silicone dioxide over sodium oxide.

Note: for an easier orientation among the examples, each example shows in bold letters “key words”, describing the example.

### Example 1

High density, ambient temperature curing, compressive strength, chemical resistance 414.0 g F-fly ash manufactured by Separation Tech. was blended with a solution of 24.8 g analytical grade potassium hydroxide manufactured by Alphachem, in 33.4 g water and 19.2 g Adi-Con SP 500 super-plasticizer (polycarboxylate manufactured by Gemite Products Inc.) using a small laboratory mixer. 84.2 g sodium silicate N solution manufactured by National Silicates, 1255.0 g well graded silica sand, and 67.4 g undensified silica fume manufactured by Norchem were added while mixing. Bars, 2.54 cm by 2.54 cm by 28.0 cm, were cast and covered in polyethylene for two days to cure; then stored under laboratory conditions.

2.54 cm by 2.54 by 2.54 cm cubes were tested for compressive strength after 14 and 64 days ambient temperature and humidity curing. Additional samples were cured in ambient air for 29 days then placed in 1% and 10% sulfuric acid for 14 days; cubes were then tested for compressive strength at 64 days. The average compressive strength of samples cured in ambient air at 14 and 64 days respectively were 33.62 and 48.32 MPa. The average 64 days compressive strength after 14 days of exposure to 1% sulfuric acid was 43.96 MPa and after 14 days of exposure to 10% sulfuric acid was 43.10 MPa. 2.54 cm by 2.54 by 2.54 cm cubes were cut and tested for chemical resistance in 36% nitric acid and 36% sulfuric acid. After 40 days, the samples showed no loss in mass.

### Example 2

High density, ambient temperature curing, compressive strength, chemical resistance 459.0 g F-fly ash manufactured by Separation Tech, and 459.0 g slag manufactured by Lafarge Corp. were blended with 2504.0 g well graded silica sand, 45.0 g undensified silica fume manufactured by Norchem, and 63.2 g dry sodium silicate G manufactured by National Silicates. The dry blend was mixed with a solution of 49.6 g analytical grade potassium hydroxide manufactured by Alphachem, in 309.0 g water using a small laboratory blender. Bars, 2.54 cm by 2.54 cm by 28.0 cm, and cubes, 5 cm by 5 cm by 5 cm, were cast; covered in polyethylene for two days to cure, and stored under laboratory conditions. Cube compressive strengths were tested after 14 and 64 days ambient temperature and humidity curing. The average compressive strength of samples cured in ambient air at 14 and 64 days respectively were 22.41 and 28.45 MPa. Additional samples were cured in ambient air for 29 days then placed in 1% and 10% sulfuric acid for 14 days; cubes were then tested for compressive strength at 64 days. The average 64 days comprehensive strength after 14 days of exposure to 1% sulfuric acid was 29.31 MPa and after 14 days of exposure to 10% sulfuric acid was 17.24 MPa. 2.54 cm by 2.54 by 2.54 cm cubes were cut from the bars, and tested for chemical resistance in 36% nitric and 36% sulfuric acids. After 40 days, the samples stored in nitric acid showed very low weight loss (2.5%). The samples stored in 36% sulfuric acid disintegrated in approximately 2 days.

### Example 3

High density, ambient temperature curing, compressive strength, chemical resistance 122.0 g slag manufactured by Lafarge Corp., 32.6 g undensified silica fume manufactured by Norchem, 9.8 g dry sodium silicate G manufactured by National Silicates, and 402.0 g well graded silica sand were blended and mixed with 7.4 g Adi-Con SP 500 super-plasticizer (polycarboxylate manufactures by Gemite Products Inc.), and a solution of 15.6 g analytical grade potassium hydroxide manufactured by Alphachem, in 106.0 g water. The mix also contained 1.2 g cellulosic fibres manufactured by Interfibe Corporation. Bars, 2.54 cm by 2.54 cm by 28.0 cm, and cubes, 5 cm by 5 cm by 5 cm, were cast; covered in polyethylene for two days to cure, and stored under laboratory conditions.

Cube compressive strengths were tested after 14 days ambient temperature and humidity curing. The average compressive strength of samples cured in ambient air at 14 days was 51.72 MPa. Additional samples were cured in ambient air for 29 days then placed in 1% and 10% sulfuric acid for 14 days; cubes were then tested for compressive strength at 64 days. The average compressive strength at 64 days after 14 days exposure to 1% sulfuric acid was 42.24 MPa and after 14 days exposure to 10% sulfuric acid was 12.07 MPa. 2.54 cm by 2.54 by 2.54 cm cubes were cut from the bars and tested for chemical resistance in 36% nitric and 36% sulfuric acids; samples disintegrated in both acids in approximately 2 days.

### Example 4

Low density, ambient temperature curing, steam curing, compressive strength, chemical resistance. 183.6 g F-fly ash manufactured by Separation Tech, 9.0 g undensified silica fume manufactured by Norchem, 0.7 g HDK-N20 (fumed silica by Wacker), 1.0 g bentonite clay manufactured by Wyo-Ben Inc., 1.35 g Adi-Con SP 200 dry superplasticizer (sodium salt melamine formaldehyde condensate, manufactured by Gemite Products Inc.) and 1.6 g Standart coated alumina particles manufactured by Eckart were blended and mixed with 30.6 g sodium silicate N solution manufactured by National Silicates, and a solution of 10.0 g analytical grade potassium hydroxide manufactured by Alphachem, in 15.8 g water. The specimens were cured at laboratory conditions until hard, approximately 30 minutes; then cut in half. Half was cured for 150 minutes in 100° C. steam; and, the remaining half was cured under laboratory conditions. The dry specific density of samples after curing at ambient temperatures for 7 and 28 days respectively was 0.41 and 0.48 g/cm³. The average compressive strength of samples after curing at ambient temperatures for 7 and 28 days respectively was 0.54 and 0.57 MPa. The dry specific density of the heat cured material after 7 and 28 days respectively was 0.39 and 0.34 g/cm³. The average compressive strength of samples after heat curing at 7 and 28 days respectively was 1.01 and 0.98 MPa. Chemical resistance in 10% and 36% sulfuric acid was tested on cube specimens, 3.8 cm by 3.8 cm by 3.8 cm, for 36 days. There was no weight loss of the specimens due to chemical attack. The weight loss of 3.5%, in 10% sulfuric acid; and, 3.5 and 2% in 36% sulfuric acid were due to handling of the specimens, and not chemical attack.

### Example 5

Medium Density, cenosphere composites, ambient temperature curing, compressive strength, compressive strength at high temperatures. 1089.0 g slag manufactured by Lafarge Corp., 405.6 g Fillite 300 cenospheres manufactured by Trelleborg, 306.0 g densified silica fume manufactured by Norchem, and 43.2 g wollastonite fibre nyad G manufactured by Nyco, were blended first and mixed with 240.0 g sodium silicate N solution manufactured by National Silicates, and a solution of 144.0 g analytical grade potassium hydroxide manufactured by Alphachem, in 360.0 g water. Cubes, 5 cm by 5 cm by 5 cm were cast. Specimens were covered in polyethylene for two days to cure, and then stored under laboratory conditions. Compressive testing was conducted after 7 and 28 days of curing at ambient temperatures; and, after 7 and 28 days with heating for 5 hours at 500° C. The average dry specific density of unheated specimens was 1.52 g/cm³. The density was reduced by heating to 1.27-1.31 g/cm³. The average strength after curing at ambient temperatures for 7 and 28 days respectively was 56.89 and 50.0 MPa. After heating the specimens for 5 hours at 500° C. the compressive strength at 7 and 28 days respectively was 37.07 and 41.38 MPa.

### Example 6

Medium Density, cenosphere composites, ambient temperature curing, compressive strength, compressive strength at high temperatures. 762.6 g slag manufactured by Lafarge Corp., 326.8 g F-fly ash manufactured by Separation Tech, 405.6 g Fillite 300 cenospheres manufactured by Trelleborg, 306.0 g densified silica fume manufactured by Norchem and 43.2 g wollastonite fibre nyad G manufactured by Nyco, were blended and mixed with 208.6 g sodium silicate N solution manufactured by National Silicates, 9.2 g Adi-Con SP 500 super-plasticizer (polycarboxylate manufactured by Gemite Products Inc.), and a solution of 89.6 g analytical grade potassium hydroxide manufactured by Alphachem, in 245.6 g water. Cubes, 5 cm by 5 cm by 5 cm, for compressive testing were cast and covered in polyethylene for two days to cure, then stored under laboratory conditions. Additional samples were stored under laboratory conditions for 7 and 28 days at ambient temperatures then heated for 5 hours at 500° c. The average dry specific density of unheated specimens after curing at ambient temperatures for 7 and 28 days respectively was 1.56 and 1.52 g/cm³. The density was reduced by heating for 7 and 28 day samples respectively to 1.33 and 1.42 g/cm³. The average strength after curing at ambient temperatures for 7 and 28 days respectively was 31.89 and 39.67 MPa. After heating specimens for 5 hours at 500° C. the compressive strength for 7 and 28 days respectively was 40.08 and 40.95 MPa.

### Example 7

Medium Density, cenosphere composites, ambient temperature curing, compressive strength, compressive strength at high temperatures, chemical resistance. 544.8 g slag manufactured by Lafarge Corp., 544.8 g F-fly ash manufactured by Separation Tech, 405.6 g Fillite 300 cenospheres manufactured by Trelleborg, 306.0 g densified silica fume manufactured by Norchem, and 43.2 g wollastonite fibre nyad G manufactured by Nyco, were blended and mixed with 211.0 g sodium silicate N solution manufactured by National Silicates, and a solution of 89.6 g analytical grade potassium hydroxide manufactured by Alphachem, in 245.6 g water. The mix also contained 7.0 g Adi-Con SP 500 super-plasticizer (polycarboxylate manufactured by Gemite Products Inc.). Cubes, 5 cm by 5 cm by 5 cm were cast and covered in polyethylene for two clays to cure, then stored under laboratory conditions. Additional samples were stored under laboratory conditions for 7 and 28 days at ambient temperatures then heated for 5 hours at 500° C.

The average dry specific density of unheated specimens after curing at ambient temperatures for 7 and 28 days respectively was 1.50 and 1.52 g/cm³. The density was reduced by heating for 7 and 28 day samples respectively to 1.30 and 1.37 g/cm³. The average compressive strength after curing at ambient temperatures for 7 and 28 days respectively was 34.05 and 28.89 MPa; and after heating for 5 hours at 500° C., the average compressive strength for 7 and 28 days respectively was 39.65 and 39.66 MPa. Additional samples were cured in ambient air for 7 days, cut approximately 2.54 cm by 2.54 cm by 2.54 cm, and then placed in 18% hydrochloric acid and 9.6% sulfuric acid. Samples were weighed daily to test chemical resistance. The average weight loss for samples in 18% hydrochloric acid over 19 days was 10.1%. The samples disintegrated in 9.6% sulfuric acid.

### Example 8

Medium Density, cenosphere composites, ambient temperature curing, compressive strength, compressive strength at high temperatures, chemical resistance. 326.8 g slag manufactured by Lafarge Corp., 762.6 g F-fly ash manufactured by Separation Tech, 405.6 g Fillite 300 cenospheres manufactured by Trelleborg, 306.0 g densified silica fume manufactured by Norchem, and 43.2 g wollastonite fibre nyad G manufactured by Nyco, were blended and mixed with 211.0 g sodium silicate N solution manufactured by National Silicates, and a solution of 89.6 g analytical grade potassium hydroxide manufactured by Alphachem, in 168.4 g water. The mix also contained 7.0 g Adi-Con SP 500 super-plasticizer (polycarboxylate manufactured by Gemite Products Inc.). Cubes, 5 cm by 5 cm by 5 cm, were cast and covered in polyethylene for two days to cure, then stored under laboratory conditions. Additional samples were stored under laboratory conditions for 7 and 28 days at ambient temperatures then heated for 5 hours at 500° C.

The average dry specific density of unheated specimens after curing at ambient temperatures for 7 and 28 days respectively was 1.46 and 1.45 g/cm³. The density was reduced by heating for 7 and 28 clay samples respectively to 1.30 and 1.37 g/cm³. The average strength after curing at ambient temperatures for 7 and 28 days respectively was 33.62 and 31.03 MPa. After heating the specimens for 5 hours at 500° C. the compressive strength for 7 and 28 days respectively was 44.83 and 32.76 MPa. Additional samples were cured in ambient air for 7 days, cut approximately 2.54 cm by 2.54 cm by 2.54 cm, and then placed in 18% hydrochloric acid and 9.6% sulfuric acid.

Samples were weighed daily to test chemical resistance. The average weight loss for samples in 18% hydrochloric acid over 24 days was 10.5%. The average weight loss for samples in 9.6% sulfuric acid over 17 days was 11.3%.

### Example 9

Medium Density, cenosphere composites, ambient temperature curing, compressive strength, compressive strength at high temperatures, chemical resistance. 1089.6 g F-fly ash manufactured by Separation Tech, 405.6 g Fillite 300 cenospheres manufactured by Trelleborg, 306.0 g densified silica fume manufactured by Norchem, and 43.2 g wollastonite nyad G manufactured by Nyco, were blended and mixed with 211.0 g sodium silicate N solution manufactured by National Silicates, and a solution of 89.6 g analytical grade potassium hydroxide manufactured by Alphachem, in 146.4 g water. The mix also contained 7.0 g Adi-Con SP 500 super-plasticizer (polycarboxylate manufactured by Gemite Products Inc.). Cubes, 5 cm by 5 cm by 5 cm, were cast and covered in polyethylene for two days to cure, then stored under laboratory conditions. Additional samples were stored under laboratory conditions for 7 and 28 days at ambient temperatures then heated for 5 hours at 500° C.

The average dry specific density of unheated specimens after curing at ambient temperatures for 7 and 28 days respectively was 1.43 and 1.45 g/cm³. The density was reduced by heating for 7 and 28 day samples respectively to 1.34 and 1.33 g/cm³. The average strength after curing at ambient temperatures for 7 and 28 days respectively was 31.03 and 26.72 MPa. After heating the specimens for 5 hours at 500° C. the compressive strength for 7 and 28 days respectively was 32.75 and 40.51 MPa. Additional samples were cured in ambient air for 7 days, cut approximately 2.54 cm by 2.54 cm by 2.54 cm, and then placed in 18% hydrochloric acid and 9.6% sulfuric acid. Samples were weighed daily to test chemical resistance. The average weight loss for samples in 18% hydrochloric acid over 21 days was 3.1%. The average weight loss for samples in 9.6% sulfuric acid over 14 days was 7.6%.

### Example 10

High Density, ambient temperature curing, compressive strength, chemical resistance. 662.4 g F-fly ash manufactured by Separation Tech, 165.6 g slag manufactured by Lafarge Corp., 2504.8 g fine well graded silica sand, 2.0 g HDK-N20 (fumed silica by Wacker), and 165.6 g undensified silica fume manufactured by Norchem, were blended and mixed with 168.4 g sodium silicate N solution manufactured by National Silicates, and a solution of 50.0 g analytical grade potassium hydroxide manufactured by Alphachem, in 226.6 g water. 7.6 g Adi-Con SP 500 super-plasticizer (polycarboxylate manufactured by Gemite Products Inc.) was added to the mix. Cubes, 5 cm by 5 cm by 5 cm were cast and covered in polyethylene for two days to cure, then stored under laboratory conditions. The dry specific density after curing at ambient temperatures for 7 and 28 days respectively was 2.23 and 2.21 g/cm³. The compressive strength of the specimens after curing at ambient temperatures for 7 and 28 days respectively was 13.81 and 19.55 MPa. Additional samples were cured in ambient air for 7 days, cut approximately 2.54 cm by 2.54 cm by 2.54 cm, and then placed in 18% hydrochloric acid and 9.6% sulfuric acid. Samples were weighed daily to test chemical resistance. The average weight loss for samples in 18% hydrochloric acid over 12 days was 4.3%. The average weight loss for samples in 9.6% sulfuric acid over 14 days was 7.6%.

### Example 11

High Density, ambient temperature curing, compressive strength, chemical resistance. 662.4 g F-fly ash manufactured by Separation Tech, 165.6 g slag manufactured by Lafarge Corp., 2504.8 g fine well graded silica sand, 2.0 g HDK-N20 (fumed silica by Wacker), and 134.8 g undensified silica fume manufactured by Norchem, were blended and mixed with 168.4 g sodium silicate N solution manufactured by National Silicates, and a solution of 50.0 g analytical grade potassium hydroxide manufactured by Alphachem, in 200.0 g water. 7.6 g Adi-Con SP 500 super-plasticizer (polycarboxylate manufactured by Gemite Products Inc.) was added to the mix. Cubes, 5 cm by 5 cm by 5 cm were cast and covered in polyethylene for two days to cure, then stored under laboratory conditions.

The dry specific density after curing at ambient temperatures for 7 and 28 days respectively was 2.21 and 2.21 g/cm³. The compressive strength of the specimens after curing at ambient temperatures for 7 and 28 days respectively was 14.65 and 20.4 MPa. Additional samples were cured in ambient air for 7 days, cut approximately 2.54 cm by 2.54 cm by 2.54 cm, and then placed in 18% hydrochloric acid and 9.6% sulfuric acid. Samples were weighed daily to test chemical resistance. The average weight loss for samples in 18% hydrochloric acid over 21 days was 4.0%. The samples in 9.6% sulfuric acid, expanded then broke apart; over 21 days the mass gain was 2.0% followed by a 4.3% loss in mass.

### Example 12

High Density, ambient temperature curing, compressive strength, chemical resistance. 662.4 g F-fly ash manufactured by Separation Tech, 165.6 g slag manufactured by Lafarge Corp., 2504.8 g fine well graded silica sand, 2.0 g HDK-N20 (fumed silica by Wacker), and 66.2 g undensified silica fume manufactured by Norchem, were blended and mixed with 168.4 g sodium silicate N solution manufactured by National Silicates, and a solution of 50.0 g analytical grade potassium hydroxide manufactured by Alphachem, in 200.0 g water. 7.6 g Adi-Con SP 500 super-plasticizer (polycarboxylate manufactured by Gemite Products Inc.) was added to the mix. Cubes, 5 cm by 5 cm by 5 cm were cast and covered in polyethylene for two days to cure, then stored under laboratory conditions. The dry specific density after curing at ambient temperatures for 7 and 28 days respectively was 2.24 and 2.19 g/cm³. The compressive strength of the specimens at 7 and 28 days respectively was 15.52 and 19.83 MPa. Additional samples were cured in ambient air for 7 days, cut approximately 2.54 cm by 2.54 cm by 2.54 cm, and then placed in 18% hydrochloric acid and 9.6% sulfuric acid. Samples were weighed daily to test chemical resistance. The average weight loss for samples in 18% hydrochloric acid over 21 days was 4.3%. The samples in 9.6% sulfuric acid, expanded then broke apart; over 21 days the mass gain was 2.0% followed by a 5.3% mass loss.

### Example 13

High Density, ambient temperature curing, compressive strength, chemical resistance. 662.4 g F-fly ash manufactured by Separation Tech, 165.6 g slag manufactured by Lafarge Corp., 2504.8 g fine well graded silica sand, 2.0 g HDK-N20 (fumed silica by Wacker), and 33.0 g undensified silica fume manufactured by Norchem, were blended and mixed with 168.4 g sodium silicate N solution manufactured by National Silicates, and a solution of 50.0 g analytical grade potassium hydroxide manufactured by Alphachem, in 200.6 g water. 7.6 Adi-Con SP 500 super-plasticizer (polycarboxylate manufactured by Gemite Products Inc.) was added to the mix. Cubes, 5 cm by 5 cm by 5 cm were cast and covered in polyethylene for two days to cure, then stored under laboratory conditions. The dry specific density after curing at ambient temperatures for 7 and 28 days respectively was 2.22 and 2.20 g/cm³. The compressive strength of the specimens at 7 and 28 day respectively was 10.92 and 14.93 MPa.

Additional samples were cured in ambient air for 7 days, cut approximately 2.54 cm by 2.54 cm by 2.54 cm, and then placed in 18% hydrochloric acid and 9.6% sulfuric acid. Samples were weighed daily to test chemical resistance. The average weight loss for samples in 18% hydrochloric acid over 21 days was 3.1%. The samples in 9.6% sulfuric acid, expanded then broke apart; over 21 days the mass gain was 2.0% followed by a 5.3% mass loss.

### Example 14

Low Density, preformed foam, ambient temperature curing, steam curing, compressive strength. 721.8 g F-fly Ash manufactured by Separation Tech, and 79.2 g slag manufactured by Lafarge Corp., were blended and mixed with 135.0 g sodium silicate N solution manufactured by National Silicates, and a solution of 39.6 g analytical grade potassium hydroxide manufactured by Alphachem, in 70.4 g water. 89.6 g preformed foam—generated in a compressor from a mixture of water and surface acting agent, Lite-Con 200 manufactured by Gemite Products Inc., in a ratio of 40:1—was added to the mix. Specimens were cast in plastic trays, cured over night then heated for 150 minutes in 100° C. steam. Cubes, approximately 4 cm by 4 cm by 4 cm, were cut; and, the dry specific densities and compressive strengths were tested. The dry specific densities of cured materials varied between 0.6-0.7 g/cm³. The average compressive strength was 2.07 MPa.

### Example 15

Low Density, preformed foam, ambient temperature curing, steam curing, compressive strength. 642.6 g F-fly Ash manufactured by Separation Tech, and 158.4 g slag manufactured by Lafarge Corp., were blended and mixed with 135.0 g sodium silicate N solution manufactured by National Silicates, and a solution of 39.6 g analytical grade potassium hydroxide manufactured by Alphachem, in 70.2 g water. 89.4 g preformed foam—generated in a compressor from a mixture of water and surface acting agent, Lite-Con 200 manufactured by Gemite Products Inc., in a ratio of 40:1—was added to the mix. The specimens were cast in plastic trays, cured over night then heated for 150 minutes in 100° C. steam. Cubes, approximately 4 cm by 4 cm by 4 cm, were cut; and, the dry specific densities and compressive strengths were tested. The dry specific densities of cured materials varied between 0.6-0.7 g/cm⁻¹. The average compressive strength was 3.15 MPa.

### Example 16

Low Density, preformed foam, ambient temperature curing, steam curing, compressive strength. 563.4 g F-fly Ash manufactured by Separation Tech, 237.6 g slag manufactured by Lafarge Corp., were blended and mixed with 135.0 g sodium silicate N solution manufactured by National Silicates, and a solution of 39.6 g analytical grade potassium hydroxide manufactured by Alphachem, in 70.2 g water. 89.4 g preformed foam—generated in a compressor from a mixture of water and surface acting agent, Lite-Con 200 manufactured by Gemite Products Inc., in a ratio of 40:1—water:Lite Con 200, was added to the mix. The specimens were cast in plastic trays, cured over night then heated for 150 minutes in 100° C. steam. Cubes, approximately 4 cm by 4 cm by 4 cm, were cut; and, the dry specific densities and compressive strengths were tested. The dry specific densities of cured materials varied between 0.6-0.7 g/cm³. The compressive strength was 4.21 MPa.

### Example 17

Low Density, preformed foam, cenosphere composites, ambient temperature curing, steam curing, compressive strength, compressive strength at high temperatures. 1089.6 g F-fly ash manufactured by Separation Tech, 405.6 g Fillite 300 cenospheres manufactured by Trelleborg, 306.0 g densified silica fume manufactured by Norchem, 43.2 g wollastonite fibre nyad G manufactured by Nyco, were blended and mixed into 211.0 g sodium silicate N solution manufactured by National Silicates, 7.0 g Adi-Con SP 500 super-plasticizer (polycarboxylate manufactured by Gemite Products Inc.), and a solution of 89.6 g analytical grade potassium hydroxide manufactured by Alphachem, in 199.0 g water. 130.2 g preformed foam—generated in a compressor from a mixture of water and surface acting agent, Lite-Con 200 manufactured by Gemite Products Inc., in a ratio of 40:1—was added to the mix. The wet mix was poured into a lined plastic container. The next day, the sample was cut in half. One half was heated for 150 minutes in 100° C. steam. Cubes, approximately 2.54 cm by 2.54 cm by 2.54 cm, were cut for compression testing. Cubes from each sample (heat cured and air cured) were dried then heated to 200° C.

The wet density was 0.65 g/cm³. The dry specific densities of samples cured at ambient temperatures for 7 and 28 days respectively were 0.636 and 0.618 g/cm³. The average compressive strength of samples cured at ambient temperatures for 7 and 28 days respectively was 1.18 and 1.75 MPa. The dry specific densities of samples cured at ambient temperatures then heated to 200° C. at 7 and 28 days respectively were 0.593 and 0.581 g/cm³. The average compressive strength of samples cured at ambient temperatures then heated to 200° C. at 7 and 28 days respectively was 2.96 and 1.64 MPa. The dry specific densities of samples cured in 100° C. steam at 7 and 28 days respectively were 0.602 and 0.580 g/cm³. The average compressive strength of samples cured in 100° C. steam at 7 and 28 days respectively was 4.16 and 4.00 MPa. The dry specific densities of samples cured in 100° C. steam then heated to 200° C. at 7 and 28 days respectively were 0.590 and 0.573 g/cm³. The average compressive strength of samples cured in 100° C. steam then heated to 200° C. at 7 and 28 days respectively was 4.78 and 6.06 MPa.

### Example 18

Low Density, preformed foam, cenosphere composites, ambient temperature curing, steam curing, compressive strength, compressive strength at high temperatures. 54.6 g slag manufactured by Lafarge Corp., 1035.0 g F-fly ash manufactured by Separation Tech, 405.6 g Fillite 300 cenospheres manufactured by Trelleborg, 306.0 g densified silica fume manufactured by Norchem, 43.2 g wollastonite fibre nyad G manufactured by Nyco, was blended and mixed with 211.0 g sodium silicate N solution manufactured by National Silicates, 7.0 g Adi-Con SP 500 super-plasticizer (polycarboxylate manufactured by Gemite Products Inc.), and a solution of 89.6 g analytical grade potassium hydroxide manufactured by Alphachem, in 180.2 g water. 133.6 g preformed foam—generated in a compressor from a mixture of water and surface acting agent, Lite-Con 200 manufactured by Gemite Products Inc., in a ratio of 40:1—was added to the mix. The wet mix was poured into a lined plastic container. The next day, the sample was cut in half. One half was heated for 150 minutes in 100° C. steam. Cubes, approximately 2.54 cm by 2.54 cm by 2.54 cm, were cut for compression testing. Cubes from each sample (heat cured and air cured) were dried then heated to 200° C. The wet density was 0.70 g/cm³. The dry specific densities of samples cured at ambient temperatures for 7 and 28 days respectively were 0.721 and 0.687 g/cm³. The average compressive strength of samples cured at ambient temperatures for 7 and 28 days respectively was 2.17 and 2.71 MPa. The dry specific densities of samples cured at ambient temperatures then heated to 200° C. at 7 and 28 days respectively were 0.671 and 0.677 g/cm³. The average compressive strength of samples cured at ambient temperatures then heated 200° C. at 7 and 28 days respectively was 2.66 and 2.95 MPa. The dry specific densities of samples cured in 100° C. steam at 7 and 28 days respectively were 0.686 and 0.663 g/cm³. The average compressive strength of samples cured in 100° C. steam at 7 and 28 days respectively was 5.50 and 6.33 MPa. The dry specific densities of samples cured in 100° C. steam then heated to 200° C. at 7 and 28 days respectively were 0.655 and 0.670 g/cm³. The average compressive strength of samples cured in 100° C. steam then heated to 200° C. at 7 and 28 days respectively was 4.24 and 5.63 MPa.

### Example 19

Low Density, cenosphere composites, gas system, ambient temperature curing, steam curing, compressive strength. 76.0 g slag manufactured by Lafarge Corp., 28.40 g Fillite 300 cenosphere manufactured by Trelleborg, 21.0 g densified silica fume manufactured by Norchem, 8.0 g dry sodium silicate G manufactured by National Silicates, 1.25 g fast reacting alumina manufactured by Eckart, 1.25 g slow reacting alumina manufactured by Eckart, and 1.0 g Adi-Con SP 200 dry superplasticizer (sodium salt melamine formaldehyde condensate, manufactured by Gemite Products Inc.), were blended together and mixed into a solution of 10.0 g analytical grade potassium hydroxide manufactured by Alphachem, in 58.0 g water. Wet mix was placed in a rectangular mold and a lid was secured using clamps. After it hardened, the sample was demolded and cut in half. One half was heat cured for 150 minutes in 100° C. steam, the other cured in air.

Samples cured at ambient temperatures for 7 and 28 days respectively had dry specific density of 0.261 and 0.257 g/cm³. The average compressive strength of samples cured at ambient temperatures for 7 and 28 days respectively was 0.86 and 0.92 MPa. Samples cured in steam at 7 and 28 days respectively had dry specific density 0.212 and 0.219 g/cm³. The average compressive strength of samples cured in heat at 7 and 28 days respectively was 0.93 and 0.97 MPa. Example 20—Low Density, gas system, ambient temperature curing, steam curing, compressive strength 183.6 g F-fly ash manufactured by Separation Tech, 9.0 g densified silica fume manufactured by Norchem, 30.60 g sodium silicate N solution manufactured by National Silicates, and 3.0 g slow reacting alumina manufactured by Eckart, were blended together and mixed into a solution of 13.0 g analytical grade potassium hydroxide manufactured by Alphachem, in 24.0 g water. Wet mix was placed in a rectangular mold and a lid was secured using clamps. After it hardened, the sample was demolded and cut in half. One half was heat cured for 150 minutes in 100° C. steam, the other cured in air. Samples cured at ambient temperatures for 7 and 28 days respectively had dry specific density of 0.226 and 0.231 g/cm³. The average compressive strength of samples cured at ambient temperatures for 7 and 28 days respectively was 0.38 and 0.39 MPa. Samples cured in steam at 7 and 28 days respectively had dry specific density 0.203 and 0.207 g/cm⁻¹. The average compressive strength of samples cured in heat at 7 and 28 days respectively was 0.41 and 0.42 MPa.

### Example 21

Low Density, cenosphere composites, gas system, ambient temperature curing, steam curing, compressive strength. 11.4 g slag manufactured by Lafarge Corp., 4.2 g Filite 300 cenospheres manufactured by Trelleborg, 165.2 g F-fly Ash manufactured by Separation Tech, 11.2 g undensified silica fume manufactured by Norchem, 30.6 g sodium silicate N solution manufactured by National Silicates, 0.7 g HDK-N20 (fumed silica by Wacker), and 3.0 g slow reacting alumina manufactured by Eckart, were blended together and mixed into a solution of 10.0 g analytical grade potassium hydroxide manufactured by Alphachem, in 23.2 g water. Wet mix was placed in a rectangular mold and a lid was secured using clamps. After it hardened, the sample was demolded and cut in half. One half was heat cured for 150 minutes in 100° C. steam, the other cured in air.

Samples cured at ambient temperatures for 7 and 28 days respectively had dry specific density of 0.306 and 0.302 g/cm³. The average compressive strength of samples cured at ambient temperatures for 7 and 28 days respectively was 0.73 and 0.72 MPa. Samples cured in steam at 7 and 28 days respectively had dry specific density 0.290 and 0.297 g/cm³. The average compressive strength of samples cured in heat at 7 and 28 days respectively was 0.74 and 0.75 MPa. Examples 22—Low Density, gas system, ambient temperature curing, steam curing, compressive strength 8.8 g calcified aluminum silicate manufactured by Engelhard Corporation, 2.9 g dry sodium silicate G manufactured by National Silicates, 5.0 g sodium aluminate manufactured by Alphachem, 0.2 g HDK-N20 (fumed silica by Wacker), and 0.6 g slow reacting alumina manufactured by Eckart, were blended together and mixed into a solution of 1.8 g analytical grade potassium hydroxide manufactured by Alphachem, in 20.2 g water. Wet mix was placed in a rectangular mold and a lid was secured using clamps. After it hardened, the sample was demolded and cut in half. One half was heat cured for 150 minutes in 100° C. steam, the other cured in air.

Samples cured at ambient temperatures for 7 and 28 days respectively had dry specific density of 0.336 and 0.332 g/cm³. The average compressive strength of samples cured at ambient temperatures for 7 and 28 days respectively was 0.41 and 0.44 MPa. Samples cured in steam at 7 and 28 days respectively had dry specific density 0.324 and 0.329 g/cm³. The average compressive strength of samples cured in heat at 7 and 28 days respectively was 0.52 and 0.56 MPa.

### Example 23

Low Density, preformed foam, cenosphere composites, ambient temperature curing, steam curing, compressive strength. 630.0 g slag manufactured by Lafarge Corp., 270.0 g F-fly ash manufactured by Separation Tech, 300.0 g Fillite 300 cenospheres manufactured by Trelleborg, 220.0 g densified silica fume manufactured by Norchem, 12.0 g Adi-Con SP 200 dry superplasticizer (sodium salt melamine formaldehyde condensate, manufactured by Gemite Products Inc.), 56.0 g sodium carbonate manufactured by Alphachem, 0.5 g ¼″ carbon fibers manufactured by Zoltek, mixed into 250.0 g sodium silicate N solution manufactured by National Silicates, and a solution of 80.0 g analytical grade potassium hydroxide manufactured by Alphachem, in 223.6 g water. Once mixed, 122.0 g preformed foam—generated in a compressor from a mixture of water and surface acting agent, Lite-Con 200 manufactured by Gemite Products Inc., in a ratio of 40:1—was added to the mix. The wet mix was poured into a lined plastic container. After curing for 24 hours the sample was cut into halves. One half was cured at laboratory conditions for 7 and 28 days; the other was heat cured for 150 minutes in 100° C. steam then allowed to cure at laboratory conditions for 7 and 28 days.

Cubes, approximately 2.54 cm by 2.54 cm by 2.54 cm, were cut for compression testing. The dry specific densities for samples cured at ambient temperatures for 7 and 28 days respectively were 0.575 and 0.5295 g/cm³. The average compressive strength for samples cured at ambient temperatures for 7 and 28 days respectively was 0.86 and 0.74 MPa. The average toughness for samples cured at ambient temperatures for 7 and 28 days respectively were 16.6 and 6.98 lb/in. The dry specific densities for samples cured in 100° C. steam at 7 and 28 days respectively were 0.576 and 0.588 g/cm³. The average compressive strength for samples cured in 100° C. steam at 7 and 28 days respectively was 1.19 and 2.39 MPa. The average toughness for samples cured in 100° C. steam at 7 and 28 days respectively were 39.36 and 45.71 lb/in.

### Example 24

Low Density, preformed foam, cenosphere composites, ambient temperature curing, steam curing, compressive strength. 630.0 g slag manufactured by Lafarge Corp., 270.0 g F-fly ash manufactured by Separation Tech, 300.0 g Fillite 300 cenospheres manufactured by Trelleborg, 220.0 g densified silica fume manufactured by Norchem, 12.0 g Adi-Con SP 200 dry superplasticizer (sodium salt melamine formaldehyde condensate, manufactured by Gemite Products Inc.), 56.0 g sodium carbonate mixed into 250.0 g sodium silicate N solution manufactured by National Silicates, and a solution of 80.0 g analytical grade potassium hydroxide manufactured by Alphachem, in 223.6 g water. 122.0 g preformed foam—generated in a compressor from a mixture of water and surface acting agent, Lite-Con 200 manufactured by Gemite Products Inc., in a ratio of 40:1—was added to the mix. The wet mix was poured into a lined plastic container. After curing for 24 hours the sample was cut into halves. One half was cured at laboratory conditions for 7 and 28 days; the other half was heat cured for 150 minutes in 100° C. steam then allowed to cure at laboratory conditions for 7 and 28 days.

Cubes, approximately 2.54 cm by 2.54 cm by 2.54 cm, were cut for compression testing. The dry specific densities for samples cured at ambient temperatures for 7 and 28 days respectively were 0.540 and 0.489 g/cm³. The average compressive strength for samples cured at ambient temperatures for 7 and 28 days respectively was 0.80 and 0.72 MPa. The average toughness for samples cured at ambient temperatures for 7 and 28 days respectively were 11.14 and 7.64 lb/in. The dry specific densities for samples cured in 100° C. steam at 7 and 28 days respectively were 0.556 and 0.569 g/cm³. The average compressive strength for samples cured in 100° C. steam at 7 and 28 days respectively was 0.91 and 2.08 MPa. The average toughness for samples cured in 100° C. steam at 7 and 28 days respectively were 36.28 and 42.93 lb/in.

### Example 25

Medium Density, foaming agent, cenosphere composites, ambient temperature curing, compressive stength. 1089.6 g F-fly ash manufactured by Separation Tech, 405.6 g Fillite 300 cenospheres manufactured by Trelleborg, 306.0 g densified silica fume manufactured by Norchem, and 43.2 g wollastonite fibre nyad G manufactured by Nyco, were blended and mixed into 211.0 g sodium silicate N solution manufactured by National Silicates, 7.0 g Adi-Con SP 500 super-plasticizer (polycarboxylate manufactured by Gemite Products Inc.), added 1.4 g foaming agent Lite-Con 300 (manufactured by Gemite Products Inc.), and a solution of 89.6 g analytical grade potassium hydroxide manufactured by Alphachem, in 199.0 g water. The wet mix was poured into a lined plastic container and covered in polyethylene for one day to cure, then stored under laboratory conditions.

The wet density was 1.39 g/mL. The average dry specific density after curing at ambient temperatures for 85 days was 1.31 g/cm³. The average compressive strength of samples after curing at ambient temperatures for 85 days was 16.8 MPa. Example 26—Medium Density, foaming agent, cenosphere composites, ambient temperature curing, compressive strength 089.6 g F-fly ash manufactured by Separation Tech, 405.6 g Fillite 300 cenospheres manufactured by Trelleborg, 306.0 g densified silica fume manufactured by Norchem, and 43.2 g wollastonite fibre nyad G manufactured by Nyco, were blended and mixed into 211.0 g sodium silicate N solution manufactured by National Silicates, 7.0 g Adi-Con SP 500 super-plasticizer (polycarboxylate manufactured by Gemite Products Inc.), added 9.8 g foaming agent Lite-Con 300 (manufactured by Gemite Products Inc.), and a solution of 89.6 g analytical grade potassium hydroxide manufactured by Alphachem, in 199.0 g water. The wet mix was poured into a lined plastic container and covered in polyethylene for one day to cure, then stored under laboratory conditions. The wet density was 1.22 g/mL. The dry specific density after curing at ambient temperatures for 81 days was 1.12 g/cm³. The average compressive strength of samples after curing at ambient temperatures for 85 days was 10.8 MPa.

### Example 27

### Medium Density, Foaming Agent, Cenosphere Composites, Ambient Temperature Curing, Compressive Strength

1089.6 g F-fly ash manufactured by Separation Tech, 405.6 g Fillite 300 cenospheres manufactured by Trelleborg, 306.0 g densified silica fume manufactured by Norchem, and 43.2 g wollastonite fibre nyad G manufactured by Nyco, were blended and mixed into 211.0 g sodium silicate N solution manufactured by National Silicates, 7.0 g Adi-Con SP 500 super-plasticizer (polycarboxylate manufactured by Gemite Products Inc.), added 14.0 g foaming agent Lite-Con 300 (manufactured by Gemite Products Inc.), and a solution of 89.6 g analytical grade potassium hydroxide manufactured by Alphachem, in 229.0 g water. The wet mix was poured into a lined plastic container and covered in polyethylene for four days to cure, then stored under laboratory conditions. The wet density was 1.0 g/mL. The dry specific density after curing at ambient temperatures for 49 days was 0.81 g/cm³. The average compressive strength of samples after curing at ambient temperatures for 85 days was 1.55 MPa.

### Example 28

1449.0 g F-fly ash manufactured by Separation Tech, 4381.2 g fine well graded silica sand, and 236.6 g undensified silica fume manufactured by Norchem, were blended first and mixed with 67.2 g Adi-Con SP 500 super-plasticizer (polycarboxylate manufactured by Gemite Products Inc.), 294.8 g sodium silicate N solution manufactured by National Silicates, 89.6 g of potassium hydroxide and 156.4 g water. A second sample was made including 14.49 g treated fumed silica (hydrophobic nanoparticle manufactured by Cabot). 2 thin plates with the dimensions, 30.8 cm by 11.4 cm by 0.6 cm, were cast and covered in polyethylene for 4-5 days. Once demolded the plates were allowed to cure at ambient temperatures for an additional 7 days.

After curing, four 1.25″ polyvinyl chloride tubes were epoxied to each plate. Once the epoxy dried (2-3 days), 18% hydrochloric acid was poured into two of the tubes on each plate and 19.2% sulfuric acid into the remaining two. After 3 days the tubes on one of the two plates were cracked open and the amount of penetration measured. The acids on the other plate were cracked open after the first signs of penetration, or 28 days afterward, whichever came first. After 3 days the hydrochloric acid had fully penetrated the 6 mm depth of the control. In the hydrophobic nanoparticle sample, the penetration was 2.54 mm in the same period. Full penetration in the hydrophobic nanoparticle sample did not take place for another 12 days, for a total of 15 days.

After 3 days, the sulfuric acid had penetrated to a depth of 4.06 mm in the control and 1.23 mm in the hydrophobic, nanoparticle sample. After 28 days, the sulfuric acid penetration in the control was 5.6 mm, while in the hydrophobic nanoparticle sample it was 2.9 mm

### Example 29

165.6 g slag manufactured by Lafarge Corp., 662.4 g F-fly ash manufactured by Separation Tech, 2503.8 g fine well graded silica sand, 2.0 g HDK-N20 (fumed silica by Wacker), and 134.8 g undensified silica fume manufactured by Norchem were blended first and mixed with 7.6 g Adi-Con SP 500 super-plasticizer (polycarboxylate manufactured by Gemite Products Inc.), 168.4 g sodium silicate N solution manufactured by National Silicates and a solution of 70.0 g sodium hydroxide in 200.6 g water. A second sample was made including 8.28 g treated fumed silica (hydrophobic nanoparticle manufactured by Cabot). 2 thin plates with the dimensions, 30.8 cm×11.4 cm×0.6 cm, were cast and covered in polyethylene for 4-5 days. Once demolded the plates were allowed to cure at ambient temperatures for an additional 7 days.

After curing, two 1.25″ polyvinyl chloride tubes were epoxied to each plate. Once the epoxy dried (2-3 days), 18% hydrochloric acid was poured into each of the tubes. After 3 days the tubes on one of the two plates were cracked open and the amount of penetration measured. The acids on the other plate were cracked open after the first signs of penetration, or 28 days afterward, whichever came first. After 3 days, the hydrochloric acid had penetrated to a depth of 4.6 mm in the control sample and 2.6 mm in the hydrophobic nanoparticle sample. The time it took for the hydrochloric acid to fully penetrate the 6 mm depth of the plates was 7 days for the control sample and 13 days for the hydrophobic nanoparticle sample.

### Example 30

Medium Density, foaming agent, cenosphere composites, ambient temperature curing, compressive strength, compressive strength at high temperatures, chemical resistance. 60.9 g F-fly ash manufactured by Separation Tech, 246.0 g Fillite 300 cenospheres manufactured by Trelleborg, 185.6 g densified silica fume manufactured by Norchem, 26.2 g wollastonite fibre nyad G manufactured by Nyco, 70.2 g 2.0 mm glass microspheres manufactured by Poraver, 86.8 g 1.0 mm glass microspheres manufactured by Poraver, mixed into 128.0 g sodium silicate N solution manufactured by National Silicates, 4.2 g Adi-Con SP 500 super-plasticizer (polycarboxylate manufactured by Gemite Products Inc.), and a solution of 54.4 g analytical grade potassium hydroxide manufactured by Alphachem, in 121.2 g water. Cubes, 5 cm by 5 cm by 5 cm, were cast and covered in polyethylene for two days to cure, then stored under laboratory conditions. Additional samples were stored under laboratory conditions for ambient, then at 7 and 28 days heated for 5 hours at 200° C.

The average dry specific density after curing at ambient temperatures for 7 and 28 days respectively was 1.12 and 1.10 g/cm³. The average strength after curing at ambient temperatures for 7 and 28 days respectively was 8.08 and 11.63 MPa. After heating the specimens for 5 hours at 200° C. the average dry specific density for 7 and 28 days respectively was 0.98 and 1.01 g/cm³. After heating the specimens for 5 hours at 200° C. the compressive strength for 7 and 28 days respectively was 11.15 and 11.63 MPa. Additional samples were cured in ambient air for 7 days, cut approximately 2.54 cm by 2.54 by 2.54 and then placed in 18% hydrochloric acid, 9.6% sulfuric acid, and 10% sodium hydroxide. Samples were weighed daily to test chemical resistance. The average weight gain for samples in 18% hydrochloric acid over 36 days was 0.7%. The average weight gain for samples in 9.6% sulfuric acid over 36 days was 10.2%.

The typical applications of the developed materials can be listed as follows:

Acid resistant coatings and mortars for use in protection of concrete against acid attack. By extending the mortars with stone aggregate an acid resistant concrete is formed. Concrete can be used in construction of acid resistant floors or in prefabrication of acid resistant bricks. Important characteristic of this material is a combination of acid and high temperature resistance. High temperature resistant coating and mortars. These can be used in lining of structures exposed to high temperatures, e.g. lining of concrete chimneys in new construction and in restoration. The materials are especially useful at high temperatures in chimney and degassing furnaces exposed to acid fumes from burning high sulfur content coal or degassing sulphur from metal ores prior to smelting the ores. The compositions exhibit a very bond to clean steel. The high bond and a high alkalinity make these materials very suitable for corrosion protection of steel.

The high cenospheres content mortars or cellular mortars are particularly suitable for “corrosion under insulation” (CUI) applications. These are application where steel pipes are hot and need to be protected against corrosion and at the same time protect the personnel from being hurt by accidentally touching the surface of the hot pipe. Very expensive high temperature resistant polymer coatings are typically applied to the surface of such pipes, and insulated with glass or mineral wool insulation. The key problem of such a system is that it is very difficult to check the status of the corrosion protection. The high content cenospheres or other type of lightweight aggregated filled binder provides thermal insulting layer and also provides an easy to check corrosion protection. The materials can also be used in precast products such as pipes, manholes or any other concrete precast elements exposed to acidic environment.

The lightweight composites can be used as acid and temperature resistant materials in form of blocks and panels in protection and thermal insulation of degassing equipment in coal power plants, metallurgy applications, in chimneys, chemical industry equipment, hot pipe insulation and many other related applications.

1. Acid and high temperature resistant cement composites, comprising a matrix of F fly ash particles ranging from 1 micron to 150 microns and/or ground slag containing around 30% by weight of calcium oxide alkali activated by sodium silicate and/or potassium hydroxides in combination with alkali metal silicates, where a concentration of potassium or sodium hydroxides varies from 3.0% to 15.0% by weight, based on a weight of the matrix (binder), defined as a weight of F-Fly ash alone or F-Fly ash in combination with ground slag, a concentration of liquid sodium or potassium silicate varies from 3-30% by weight, based on liquid sodium or potassium silicates, containing 8.9% Na₂O or K₂O and 28.7% SiO₂, this based on a weight of the matrix (binder), when using solid sodium or potassium silicates, a typical content varies from 1% to 15% by a weight of the matrix (binder), this based on the weight of the matrix (binder), wherein solid sodium or potassium silicates contain 19% Na₂O or K₂O and 61% of SiO₂

2. Acid and high temperature resistant cement composites according to claim 1, comprising retarders comprising at least one of citric acid, sodium citrate, tartaric acid and sodium tartarate, or other organic acid compounds from 0 to 2% by the weight of the matrix (binder).

3. Acid and high temperature resistant cement composites according to claim 1, comprising an un-densified silica fume-condensed silica fume, the amorphous silicone dioxide obtained as by products in production of ferro-silicones, the amount of condensed silica fume varies from 0% to 30% by weight, by the weight of the matrix (binder).

4. Acid and high temperature resistant cement composites according to claim 3 comprising precipitated nano-particle silica made from soluble silicates and nano-particle silica fume produced by burning silicon tetra chloride in the hydrogen stream, wherein a quantity of fume silica varies from 0 to 5% by the weight of the matrix (binder).

5. Acid and high temperature resistant cement composites according to claim 1, wherein an additional part of the composite are the fillers as silica sand for mortars for incorporation of sand and stone fillers results in composite densities from 2.1 g/cm³ to approximately 2.45 g/cm³.

6. Acid and high temperature resistant cement composites according to claim 1, comprising agents based on poly-carboxylates

7. Acid and high temperature resistant cement composites according to claim 1, comprising hydrophobic particles comprising at least one of silane treated fume silica or other hydrophobic.

8. Acid and high temperature resistant cement composites according to claim 1, comprising, using mathematical modeling, minimizing the free inter-particle space (porosity) of different distributions.

9. Acid and high temperature resistant cement composites according to claim 1 wherein the cement systems is heating to temperatures up to 80-100° C. by steam curing.

10. Acid and high temperature resistant cement composites according to claim 1, wherein the matrix is combined with cenospheres (lightweight fraction of fly ash) or lightweight aggregates from the group of perlite, expanded shale and clay.

11. Acid and high temperature resistant cement composites according to claim 1, wherein the matrix is combined with porous recycled glass particles of different particle size grades varying from 0.1 to 8 mm.

12. Acid and high temperature resistant cement composites according to claim 1, wherein the matrix is blended with preformed foam.

13. Acid and high temperature resistant cement composites according to claim 1, wherein an air cellular structure is introduced within the matrix on mixing.

14. Acid and high temperature resistant cement composites according to claim 1, wherein a the cell structure is formed by generating gas during the hardening of the matrix

15. Acid and high temperature resistant cement composites according to claim 13, wherein the pre-formed foam is produced in a foam generator using water, compressed air and a suitable surface acting agent.
